(19) United States
(12) Patent Application Publication
(10) Pub. No.: US 2015/0039409 A1
(43) Pub. Date: Feb. 5, 2015

(54) Methods And Systems For Providing Scan Triggered Application Services

(71) Applicant: Flashback Survey, Inc., Chapel Hill, NC (US)

(72) Inventors: Peter Joseph Marsico, Chapel Hill, NC (US); Sir Robert Burbridge, Durham, NC (US)

(21) Appl. No.: 14/328,654

(22) Filed: Jul. 10, 2014

Related U.S. Application Data
(60) Provisional application No. 61/957,819, filed on Jul. 13, 2013.
(60) Provisional application No. 61/959,531, filed on Aug. 26, 2013.

(51) Int. Cl. G06Q 30/02; G06K 7/10

(52) U.S. Cl. CPC G06Q 30/0217; G06K 7/10366; G06K 7/10544; G06K 2007/10524
USPC 705/14.19; 705/14.1

(57) ABSTRACT

Disclosed are methods, systems and computer program products for providing scan-triggered application services to a user using a scan-able information encoded in a service scan code, such as a bar code, a quick response (QR) code, an RFID code/tag, or an NFC code/tag. In one embodiment, a mobile communication device such as a smartphone, tablet computer or other mobile computer is adapted to include a scan-triggered service client module for scanning and communicating scan code information obtained from a scanable service code. In one exemplary embodiment, service scan code scanning is accomplished by a code scanner that is associated with the smartphone or other mobile computing device. The scan-triggered service client module communicates the obtained scan code information to an associated server application for collecting and processing the scan code information and providing the associated service. The server application is adapted to grant the scanning user a digital reward that has an initial value at the time of the grant, and to subsequently alter the worth of the reward to a second value at some time after the time of the grant.

### PRIORITY CLAIM

This application claims the benefit of U.S. Provisional Patent Application Ser. No. 61/957,819, filed Jun. 13, 2013, and U.S. Provisional Patent Application Ser. No. 61/959,531, filed Aug. 26, 2013; the disclosures of which are incorporated herein by reference in their entireties.

### TECHNICAL FIELD

The subject matter described herein relates to methods and systems for providing scan-triggered application services to a user using scan-able codes and the distribution of associated rewards.

### BACKGROUND OF THE INVENTION

Information collection systems that are typically deployed to gather information from a consumer of goods and services are often intrusive and time consuming from the perspective of the consumer. Such information collection systems often require the consumer to manually browse to a WEB site that presents the consumer with a series of questions to be completed and do not necessarily provide the consumer with substantial utility. While such information collection systems are capable of gathering detailed feedback information from a consumer, the time and effort required to provide the requested feedback information is such that many consumers chose not to participate. Such systems do not provide a comprehensive platform through which information collection and service access for multiple data collection entities, such as retail merchants, can be facilitated and supported.

In light of these problems, what is needed is a comprehensive and robust system and method for providing users with scan-triggered application services and for rewarding or incentivizing users to access such services.

### SUMMARY OF THE INVENTION

According to one aspect, the present invention includes systems and methods for providing scan-triggered application services, such as for example user feedback surveying, using a scan code, such as a bar code, a quick response (QR) code, an RFID tag/code, a NFC tag/code, or other scan-able code element. In one embodiment, a mobile communication device such as a smartphone, tablet computer or other mobile computer is adapted to include a scan-triggered service client module for scanning and communicating QR code information. QR code scanning is accomplished by a camera module that is associated with the smartphone or other mobile computing device. The scan-triggered service client module communicates the scanned QR code service information to an associated server application for collecting, processing and reporting survey data. In one embodiment, the application service code information contained in the scanned QR code is decoded by the scan-triggered service client module and communicated to the associated server application. The application service code information encoded in the QR code may include information that is sufficient to identify a client entity (e.g., a local retailer or merchant) and a survey response option. The server application is adapted to receive the scanned information sent by the scan-triggered service client module and to store, analyze and generate reports based on the information.

In another embodiment, an image (e.g., JPEG, bitmap, etc.) of the scanned QR code icon is provided by the scan-triggered service client module to the associated server application. In this case, the server application is adapted to decode the information encoded in the QR code, and to subsequently store, analyze and generate reports based on the information.

According to another aspect, the present invention includes systems and methods for distributing and redeeming a digital coupons or rewards to a user who scans a scan-triggered application service code, such scan-triggered survey or feedback scan code. In one embodiment, reward voucher content information (e.g., text which describes the reward voucher, a graphic image associated with the reward voucher, etc.) is communicated from the server application to the scan-triggered service client module. At least a portion of the survey participation reward voucher content information is displayed to the user associated with the mobile communication device. The user may select the participation reward voucher for redemption. The value of the reward may be dynamically altered at various times and the altered values displayed to the user.

According to another aspect, the present invention includes systems and methods for distributing and redeeming a digital coupons or rewards to a user who scans a scan-triggered application service code, such scan-triggered survey or feedback scan code. In one embodiment, reward voucher content information (e.g., text which describes the reward voucher, a graphic image associated with the reward voucher, etc.) is communicated from the server application to the scan-triggered service client module. At least a portion of the survey participation reward voucher content information is displayed to the user associated with the mobile communication device. A user may select a received reward and cause copies or clones of the reward to be created and distributed to other users.

According to another aspect, the present invention includes systems and methods for collecting and tabulating scan-triggered votes. In one embodiment, voting ballot options may each be assigned a unique scan code value. Scanning of the vote response code, causes a vote to be cast and subsequently tabulated for the associated vote option. In another embodiment, a scan code may be associated with a voting ballot that includes multiple voting options. Scanning of the ballot code, causes one or more vote response options to be displayed to the scanning user, who can select a vote response option and thereby cast the associated vote, which is subsequently tabulated.

According to another aspect, the present invention includes systems and methods for associating a user with a contact list, such as an email distribution contact list. In one embodiment, a contact list may each be assigned a unique scan code value. Scanning of the contact list scan code causes user identifying information that has been previously stored on the user's mobile device to be accessed and used to subscribe the user to the contact list associated with the scanned contact list code.

According to another aspect, the present invention includes systems and methods for distributing and redeeming a digital coupons or rewards to a user who scans a scan-triggered application service code, such scan-triggered survey or feedback scan code. In one embodiment, reward voucher content information (e.g., text which describes the reward voucher, a graphic image associated with the reward voucher, etc.) is communicated from the server application to the scan-triggered service client module. At least a portion of the survey participation reward voucher content information is displayed to the user associated with the mobile communication device. A user may submit a request to extend the expiration time/date associated with a reward that they have been previously granted. In response to receiving the expiration extension request, the expiration time/date of the reward may be extended to a later time/date.

According to another aspect, the present invention includes systems and methods for scan code-based information from a user who scans a scan-triggered application service code and to subsequently relay at least some of the information collected from the scan to a third-party application server, such as a server associated with the user's social media account.

According to another aspect, the present invention includes systems and methods for enabling a content creator entity, such as a merchant, to remotely control the operational status of a scan-triggered immediate notification service.

According to another aspect, the present invention includes systems and methods for enabling a user to communicate information associated with the scanning of a scan-triggered application service code to a server associated with the scan-triggered application service, in such a manner such that the server is able to determine that the received scan-related information should be treated as being anonymous.

According to another aspect, the present invention includes systems and methods for enabling a user to scan a scan-triggered application service code and obtain a preview of an associated service action before the action is committed.

According to another aspect, the present invention includes systems and methods for enabling a scan-triggered application service, where encoded in a scan-triggered application service code is an encrypted or obfuscated uniform resource locator (URL) that is used to access a scan-triggered application service.

The subject matter described herein for facilitating scan-triggered application services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer perform steps. Exemplary computer readable media suitable for implementing the subject matter described herein include disk memory devices, programmable logic devices, application. specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a functional block diagram which illustrates a mobile communication device that includes a camera and exemplary scan-triggered service client module;

FIG. 2 is a functional block diagram which illustrates an application server that includes an exemplary server application module;

FIG. 3 is a diagram that illustrates exemplary user, client and survey participation reward provisioning data;

FIG. 4 is a diagram that illustrates exemplary primary and follow-up survey content data;

FIG. 5 is a diagram that illustrates exemplary survey response data;

FIG. 6 is a diagram that illustrates exemplary survey participation reward redemption data;

FIG. 7 is an information flow diagram that illustrates an exemplary scan-triggered survey transaction and an associated follow-up survey transaction;

FIG. 8 is an information flow diagram that illustrates an exemplary distribution of a survey participation reward and associated reward redemption processing;

FIG. 9 is an information flow diagram that illustrates exemplary provisioning and data reporting transactions;

FIG. 10 is an information flow diagram that illustrates exemplary dynamic reward value functionality according to one embodiment of the present invention;

FIG. 11 is an information flow diagram that illustrates exemplary digital reward copying or cloning functionality according to one embodiment of the present invention;

FIGS. 12A and 12B are information flow diagrams that illustrates exemplary scan-triggered opinion polling and voting functionality according to embodiments of the present invention;

FIG. 13 is an information flow diagram that illustrates exemplary scan-triggered digital contact list management functionality according to one embodiment of the present invention;

FIG. 14 is an information flow diagram that illustrates exemplary digital reward expiration extension functionality according to one embodiment of the present invention;

FIGS. 15A and 15B are information flow diagrams that illustrates exemplary scan-triggered social media relay functionality according to embodiments of the present invention;

FIG. 16 is an information flow diagram that illustrates exemplary remote control of immediate notification functionality according to one embodiment of the present invention;

FIG. 17 is an information flow diagram that illustrates exemplary scan-triggered service user anonymity functionality according to one embodiment of the present invention;

FIG. 18 is an information flow diagram that illustrates exemplary scan-triggered service preview functionality according to one embodiment of the present invention; and

FIG. 19 is an information flow diagram that illustrates the exemplary use of encrypted or obfuscated uniform resource locator scan-triggered service access information according to one embodiment of the present invention.

### DETAILED DESCRIPTION OF THE INVENTION

### Detailed Description

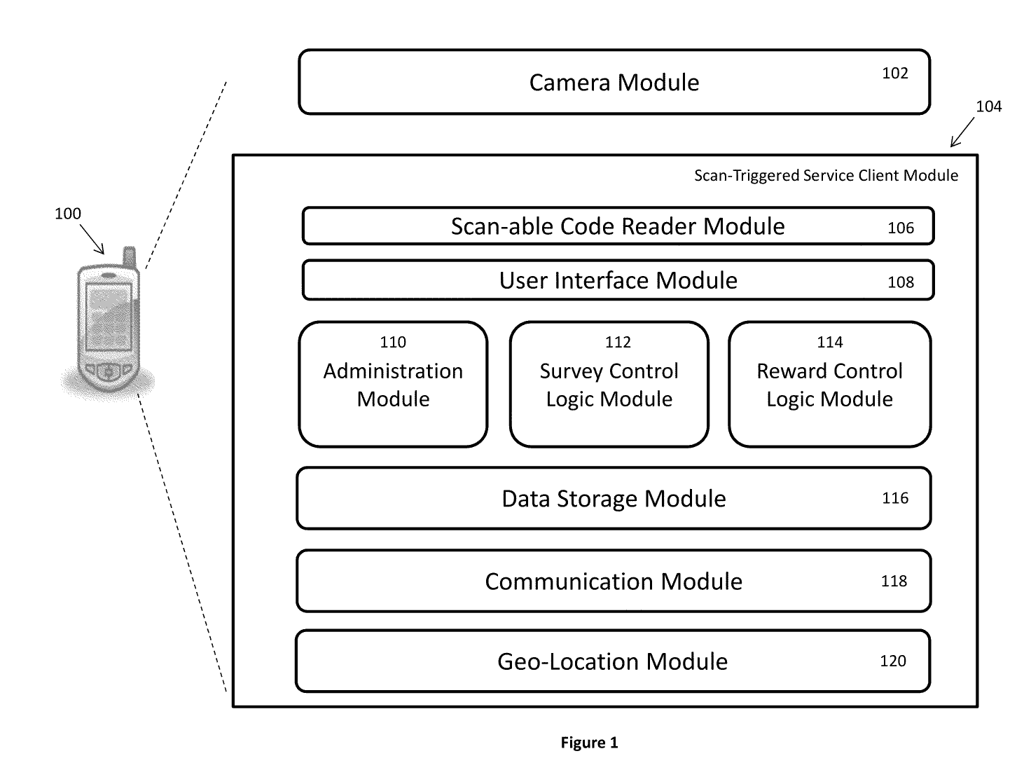

Disclosed are systems and methods for providing scan-triggered application services to a user (e.g., mobile phone user), for the issuance of associated participation rewards, and the collection and reporting of usage data associated with such scan-triggered services. In one exemplary embodiment of the present, a scan-triggered application service is adapted to facilitate the collection of survey information from a user with regard to a good or service provided by a surveying entity (e.g., retailer, merchant, corporation, etc.), and for processing and reporting the collected survey information to the surveying entity. In one embodiment, subject-specific survey information is collected from a user via the scanning of a scanable survey code and utilized by a scan-based survey system. Exemplary subject-specific survey areas include, but are not limited to, staff service, food quality, store ambience, cleanliness, etc. Exemplary surveying entities include, but are not limited to, commercial enterprises, such as wholesale or retail businesses, medical and dental practices, restaurants, etc. In a preferred embodiment, the subject matter described herein includes a scan-triggered service client module, which may be implemented in hardware, software, firmware or a combination thereof and which resides on a mobile communication device, such as a smartphone, tablet computer, netbook computer, computer integrated eyeglasses or other mobile computing device. The scan-triggered service client module may include an executable computer program or application (e.g., C++, Java, etc.) that is adapted to be downloaded onto the mobile communication device, installed and executed. The scan-triggered service client module may also include a web browser that is adapted to access and execute web-based, web-app software that provides some or all of the necessary scan-triggered service functionality. Shown in FIG. 1 is a block diagram that illustrates an exemplary architecture of a smartphone-based scan-triggered service client module. Smartphone 100 includes a camera module 102 that is adapted to capture and store an image in a digital format. Smartphone 100 also includes a scan-triggered service client module 104. Scan-triggered service client module 104 is comprised of scan code reader module 106, a user interface module 108, an administration module 110, a scan control logic module 112, a survey participation reward control logic module 114, a data storage module 116, and a communication module 118.

In one embodiment, scan code reader module 106 is adapted to receive digital image information associated with a photographed scan code icon, such as a quick response (QR) code, bar code, or other graphic encoding format. Reader module 106 analyzes and decodes or extracts digital information encoded within the scan code icon image. The extracted information may comprise information that is representative, for example, of an alphanumeric text string, a numeric code. The extracted information may identify a surveying entity (e.g., business entity) and a surveying entity location (e.g., a store or retail location associated with a business entity). The extracted information also identifies a specific survey subject area (e.g., service quality, food quality, location ambiance, etc.). It will be appreciated that a survey subject area may be presented to a user in the form of a question (e.g., “How was the food quality?” etc.). The decoded scan code information is provided to an associated server application module via communication module 118. In an alternate embodiment, scan code reader module 106 is adapted to receive digital image information from camera module 102 and to communicate the digital image information (e.g., JPEG) to an associated server application module via communication module 118 where decoding processing is performed. In one embodiment, information that identifies or can be used to identify a scan-triggered service user (e.g., user name, user ID, session ID, etc.) is also provided to the server application module.

User interface module 108 is adapted to present the mobile device user with a graphical user interface for enabling the user to generally control and operate the functionality of the scan-triggered service client module. User interface module 108 is adapted to present a menu structure to the user and enable the user to navigate this menu structure. The menu structure provides a user with access to administrative functions, such as account settings (e.g., username, password, service preferences, personal information, etc.), account log-in. Such administrative functions are controlled within scan-triggered service client module 104 via administration module 110. The menu structure may also provide the user with the ability to control the associated smartphone camera. In some embodiments, the ability to access and operate the smartphone camera in the manner required to effectively photograph or scan a scan code icon, such as a QR code, is provided via scan control logic module 112. In one exemplary embodiment, a scan-triggered service client module may include a native application that is adapted to execute on the mobile device, and in such a case that native application may include QR scanning/decoding capability or alternatively the scan-triggered service client module may simply invoke the services of a third-party QR scanner/decoder that is installed in the mobile device. In another exemplary embodiment, a third-party QR scanner/decoder may be invoked by the mobile device user to scan and decode a suitably provisioned QR, where decoding of the QR code causes a web browser instance to be launched and directed to a URL associated with the application server. In this case, information that identifies the surveying entity and subject-specific survey may be passed to the application server via the URL/URL parameters. For example, in one embodiment, information that identifies the surveying entity and/or the subject-specific area may be explicitly or implicitly communicated to the application server via the URL itself (e.g., the host name and/or path and/or query string components of the URL can be used by the application server to explicitly or implicitly identify the surveying entity). In an alternate embodiment, for example, all communications between the user's mobile device and the application server may be addressed to a URL which points to a scan-based service provider (e.g., www.flashbacksurvey.com), and the information that identifies the surveying entity and/or the subject-specific area may be communicated to the scan-based service provider's application server via the path and/or query string parameter portions of the URL. The menu structure also provides the user with the ability to access and redeem survey participation rewards. Survey participation reward access and redemption functionality is provided by survey participation reward control logic module 114.

Data storage module 116 is adapted to provide both long term storage of data associated with the scan-triggered service, as well as short term, cache-type storage of surveying entity related data. Exemplary uses of the data storage are discussed in more detail in the disclosure that follows.

Communications module 118 is adapted to facilitate the communication of information between scan-triggered service client module 104 and an associated server application module. For example, communication module 118 may receive information from Scan Control Logic Module 112 that is to be communicated to an associated server application module. Communication module 118 may package the information according to a pre-defined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), Long Term Evolution (LTE), WiMax, WiFi, etc. For example, in one embodiment, when a user scans a survey response QR code, communication module 118 is adapted to communicate to an associated server application module information that was encoded in the scanned survey response QR code as well as information that can be used to identify the user. Information that can be used to identify the user may include a user identifier (e.g., username, email address, mobile IP address, communication session ID, etc.). It will be appreciated that the communication of such user identifying information to the server module may be triggered upon scanning of the QR code or may be triggered upon startup of software associated with scan-triggered service client module 104 (e.g., auto-login, manual login, etc.).

In one exemplary embodiment, geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling the server application module to identify and store the location at which a QR code was scanned.

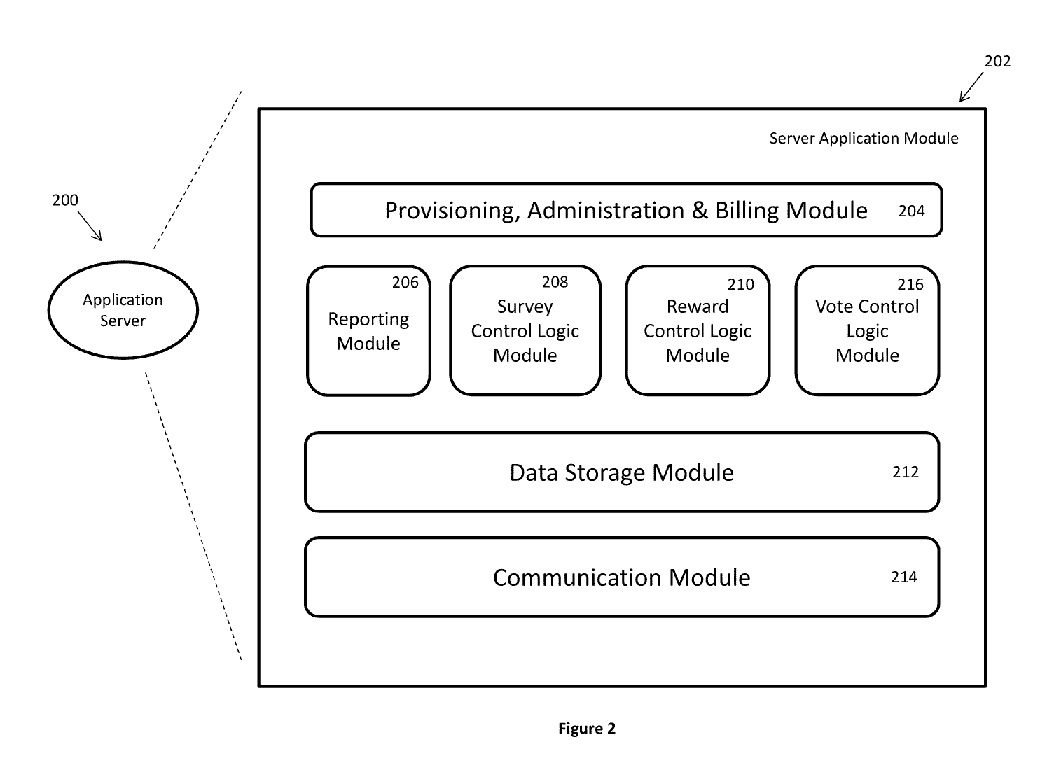

Shown in FIG. 2 is a block diagram that illustrates an exemplary architecture of a server application module 202, which resides and executes on a network or cloud-hosted application server 200. In the embodiment presented in FIG. 2, the server application module is comprised of a provisioning, administration and billing module 204, a reporting module 206, a survey logic control module 208, a reward control logic module 210, a data storage module 212, and a communication module 214.

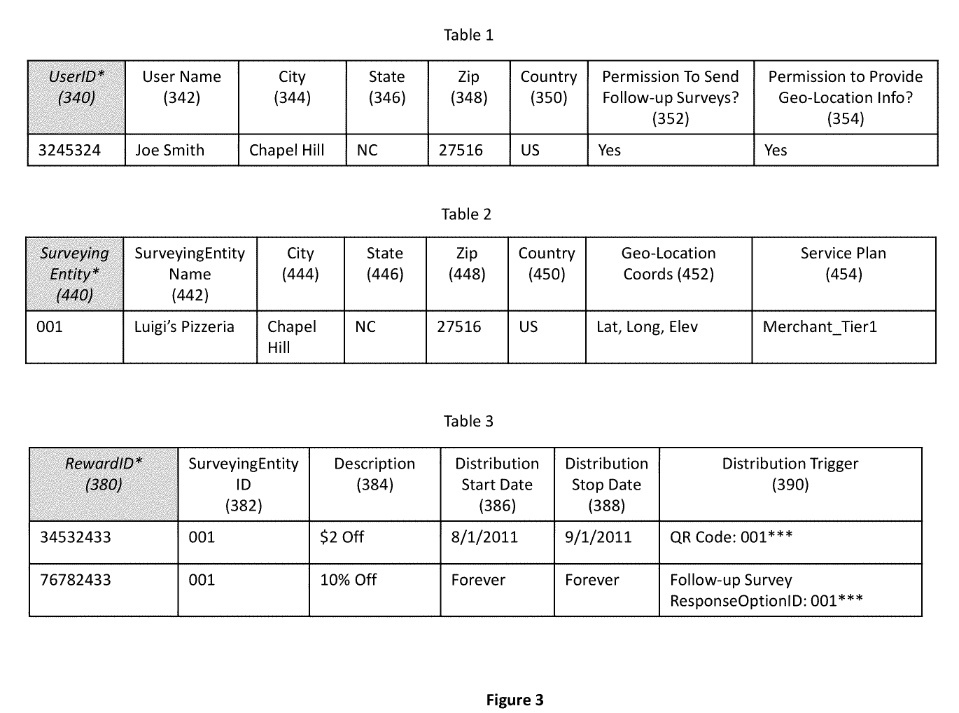

Provisioning, administration and billing module 204 is adapted to provide access for a user, such as a surveying entity, mobile user entity or a system administrator, to provision registration information, subscription configurations/preference information, survey content information, and survey participation reward content information. Exemplary user registration and configuration settings information is presented in Table 1, as shown in FIG. 3. In the context of this disclosure, a user is considered to be the operator or user of a mobile communication device (e.g., smartphone, tablet computer, etc.) that includes a scan-triggered service client module, and is therefore capable of scanning a QR code (or other encoded, optically scanable icon) and providing survey data to an associated application server. For example, a user may be a consumer of goods and services provided by a merchant, or an employee of a business or corporation.

Table 1 includes UserID information 340, user name information 342, user city 344, user state 346, user zip code 348, user country 350, Follow-up Survey permission information 352, and geo-location data sharing permission information 354. The user information shown in Table 1 is merely exemplary and is not intended to be a comprehensive listing. Exemplary surveying entity registration and configuration settings information is presented in Tables 2 and 3, as shown in FIG. 3. In the context of this disclosure, a surveying entity is considered to be an entity that wishes to survey a user. For example, a surveying entity may be a retailer or merchant of goods and services, or a corporation that wishes to survey its employees. Table 2 includes SurveyingEntityID information 440, SurveyingEntity name information 442, SurveyingEntity city 444, SurveyingEntity state 446, SurveyingEntity zip code 448, SurveyingEntity country 450, SurveyingEntity geo-location data 452, and service plan information 454. The surveying entity information shown in Table 2 is merely exemplary and is not intended to be a comprehensive listing. Table 3 includes survey participation reward identification information 380, surveying entity identification information 382, survey participation reward description information 384, reward distribution start date information 386, reward distribution stop date information 388, and reward distribution trigger criteria information 390.

Returning to FIG. 2, a surveying entity, such as a restaurant owner, may log in to server application module 202 and, via module 204, construct or provision survey content associated with a survey of customer satisfaction with the service at the owner's restaurant. The surveying entity may implicitly or explicitly define a survey subject area or category (e.g., Wait Staff Service) and one or more survey questions associated with the survey subject area or category, such as “Was the wait staff friendly?” Information that identifies the survey subject area or category and the associated question are stored in a data structure or database associated with data storage module 212. One or more response options associated with the survey question are also defined and stored in data storage module 212. Exemplary responses might include, “Yes” and “No”. In one embodiment, each survey response option is categorized according to the disposition of the response option. For example, a response option may be categorized as “positive”, “negative”, or “neutral.” Multiple response disposition categories, may be associated with a single response option. As such, survey responses collected from users can be quickly grouped, analyzed and displayed according to disposition category.

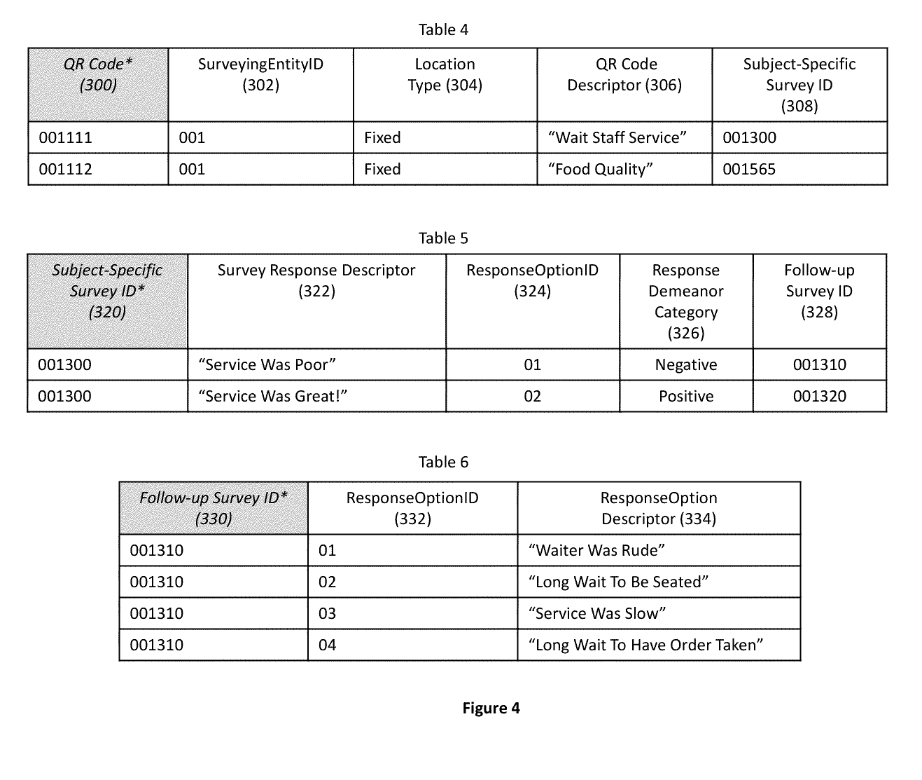

In one embodiment, a code is associated with a predefined survey subject area for a surveying entity. As such, the code is explicitly associated with and uniquely identifies both a surveying entity and a subject-specific survey or survey area. Exemplary subject-specific survey content data is presented in Table 4, shown in FIG. 4. Each exemplary survey content record in Table 4 includes a QR code identifier 300, a SurveyingEntityID 302, a location type indicator 304, QR code descriptor text descriptor information 306, and subject-specific survey identification information 308. It will be appreciated, in the sample data shown in Table 4, that the QR code identifier values chosen incorporate the SurveyingEntityID value in the first three digits (i.e., 001). As such, the QR code assigned to the subject-specific survey area “Wait Staff Service” includes information that is sufficient to explicitly identify both the surveying entity (i.e., “Luigi's Pizzeria”) with which the survey is associated and the subject-specific survey area (i.e., “Wait Staff Service”).

Provisioning, administration and billing module 204 is adapted to generate an encoded scanable graphic icon (e.g., QR code icon) associated with each possible subject-specific survey area, where the information encoded in the scanable graphic icon includes information that can be used to identify the surveying entity and the associated subject-specific survey area of interest.

According to one aspect of the subject matter described herein, in response to the scanning of a scanable graphic code (e.g., QR code) that encodes a surveying entity identifier and a subject-specific survey area identifier, survey content information associated with the surveying entity and specified subject area is sent to the mobile device of the user who scanned the QR code. Shown in FIG. 4 are Tables 5 and 6, which illustrate an exemplary subject-specific survey data structure that may be provisioned for a surveying entity via module 204. Table 5 includes Subject-specific survey ID information 320, survey response descriptor information 322, ResponseOptionID information 324, Response Demeanor Category information 326, and optional Follow-up Survey ID information 328. Table 6 includes Follow-up survey ID information 330, ResponseOptionID information 332, and ResponseOption Descriptor information 334. With regard to Response Demeanor Category information 326, it will be appreciated that by pre-associating a response demeanor category (e.g., this response option should be interpreted as positive feedback, this response option should be interpreted as negative feedback, this response option should be interpreted as neutral feedback, etc.) with each response option, subject-specific survey response feedback from a large population of users may be quickly and easily aggregated for reporting and viewing purposes. For example, a surveying entity can easily log-in to the surveying system and chose to view a real-time report that organizes and presents user feedback in terms of all received “positive” feedback or all received “negative” feedback. The ability to categorize and sort survey feedback response information by demeanor category is a very useful and important feature/aspect of the subject matter described herein.

Continuing with the previous survey example, if a user scans the QR code icon that encodes the value “001111” which is associated with the subject-specific survey area “Wait Staff Service” (see Table 4, record 1), subject-specific survey content is subsequently sent and displayed to the user. In this example, the subject-specific survey content includes the response statements/options “Service Was Poor” and “Service Was Great!” Further associated with the “Service Was Poor” response option are five follow-up survey response options that are presented to the user in the event that user selects the “Service Was Poor” response option. User input with regard to these subject-specific survey and associated follow-up survey solicitations is communicated from the mobile device to the server application where it is validated, stored, analyzed and reported to the surveying entity. It will be appreciated that additional follow-up survey content, associated with some or all of the five follow-up response options, may be provisioned and communicated to a user during the course of a survey transaction/session and as such multiple levels of follow-up survey content “nesting” is contemplated.

Reporting module 206 is adapted to provide access to survey data that has been collected as well as to survey participation reward distribution and redemption information. In one embodiment, reporting module 206 analyzes collected survey data and generates summary reports associated with the survey data. Module 206 may generate and report statistics that are based on collected survey data. Reports generated by module 206 may be viewed, for example, by a surveying entity via a web browser or other software interface. Module 206 may also provide survey, participation reward and redemption data and associated statistics in a downloadable format, such as a spreadsheet or portable document format. In one embodiment, report module 206 may enable a user to access and view user account information, including user settings, user preferences, survey participation rewards earned, survey participation reward redemption information, survey participation reward transfers to other users, etc.

Returning to FIG. 2, according to one aspect, Scan Control Logic Module 208 is adapted to receive and process scanned survey code (e.g., QR code) information from one or more scan-triggered services. Module 208 facilitates selection and distribution of survey content based on the surveying entity and survey subject area specified in the received scan information. In one exemplary embodiment, module 208 is further adapted to facilitate the storage of collected subject-specific survey response information within an associated data storage module. In an alternate embodiment, module 208 is adapted to decode or “read” an image provided by a scan-triggered service client module. The image may be, for example, a JPEG formatted graphic image of a QR code icon. The decoded information extracted from the QR code icon is then processed and the subsequently received subject-specific survey response option information stored in a manner similar to that described above. Module 208 may also access provisioned follow-up survey rules and communicate follow-up survey content to the user based on the provisioned rules. Module 208 may subsequently receive follow-up survey response information from the user, and log or record this follow-up survey response information and again access the provisioned follow-up survey rules and, communicate additional follow-up survey content to the user based on the provisioned rules.

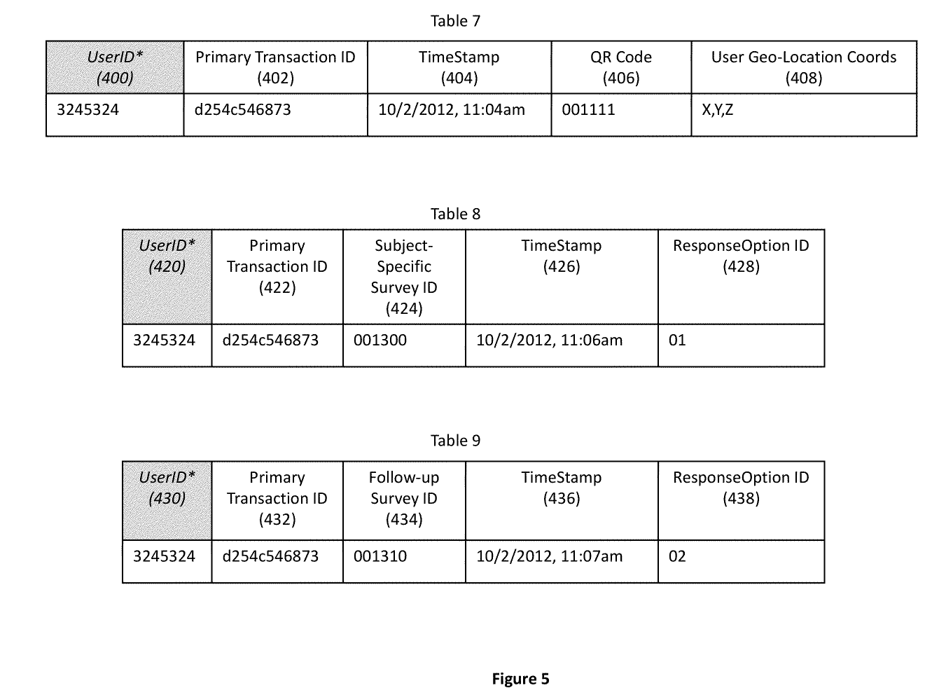

Shown in FIG. 5 are Tables 7, 8 and 9, which illustrates an exemplary survey response transaction data structure that is maintained, for example, in data storage module 212. Table 7 includes UserID information 400, survey response transaction identifier information 402, transaction timestamp information 404, scanned survey response code (e.g., QR code) information 406, and user geo-location coordinate information at the time of the survey response transaction 408. Table 8 includes UserID information 420, survey response transaction identifier information 422, subject-specific survey identification information 424, transaction timestamp information 426, and response option identification information 428. Table 9 includes UserID information 430, survey response transaction identifier information 432, follow-up survey identification information 434, transaction timestamp information 436, and response option identification information 438.

Returning to FIG. 2, reward control logic module 210 is adapted to operate in conjunction with module 208 so as to receive or be informed of scanned subject-specific survey code (e.g., QR code) and/or associated survey response information provided by a user/scan-triggered service client module. In one embodiment, module 210 is adapted to distribute a survey participation reward, such as a coupon or voucher that may be exchanged for a good or service, to a user based on survey scan code (e.g., QR code) information received from the user or from follow-up survey response information received from the user. To determine which survey participation reward content to distribute, module 210 may access provisioned reward rules data, such as the exemplary survey participation reward data shown in Table 3.

In an alternate embodiment, module 210 is adapted to distribute survey participation reward content to a user based on criteria other than received survey scan code or follow-up survey response information. For example, module 210 may distribute reward content based on the number of survey response events or transactions initiated by a user. In one scenario, a user is sent a survey participation reward by module 210 for every 25^{th} survey response event associated with the user. In another scenario, module 210 may periodically or randomly distribute reward content to a user.

Module 210 is also adapted to receive and process a request by a user/scan-triggered service client module to redeem a survey participation reward. The user/scan-triggered service client module requesting to redeem a survey participation reward provides information which identifies the reward to be redeemed and the redemption entity. A redemption entity is defined herein as any entity (e.g., retail merchant, corporation, etc.) that exchanges a survey participation reward for a good or service. Module 210 is adapted validate the redemption request. Validation of a redemption request may include, but is not limited to, confirming that the requesting user has been previously given the reward associated with the redemption request, confirming that the reward associated with the redemption request has not expired, confirming that the redemption entity information provided is valid, confirming that the user is in good standing.

In one embodiment, module 210 may facilitate the sharing, gifting, or transfer of a survey participation reward from one user to another user. In this case, a first user who is the current owner of a survey participation reward, selects the reward and identifies a second user to whom the reward is to be transferred. The first user then communicates information that identifies both the reward and the “transferred to” user to module 210. Module 210 receives, processes and logs the transfer request and updates the appropriate reward data so as to execute the transfer. In one embodiment, reporting module 206 enables a surveying entity or user to view, track and analyze such reward transfers.

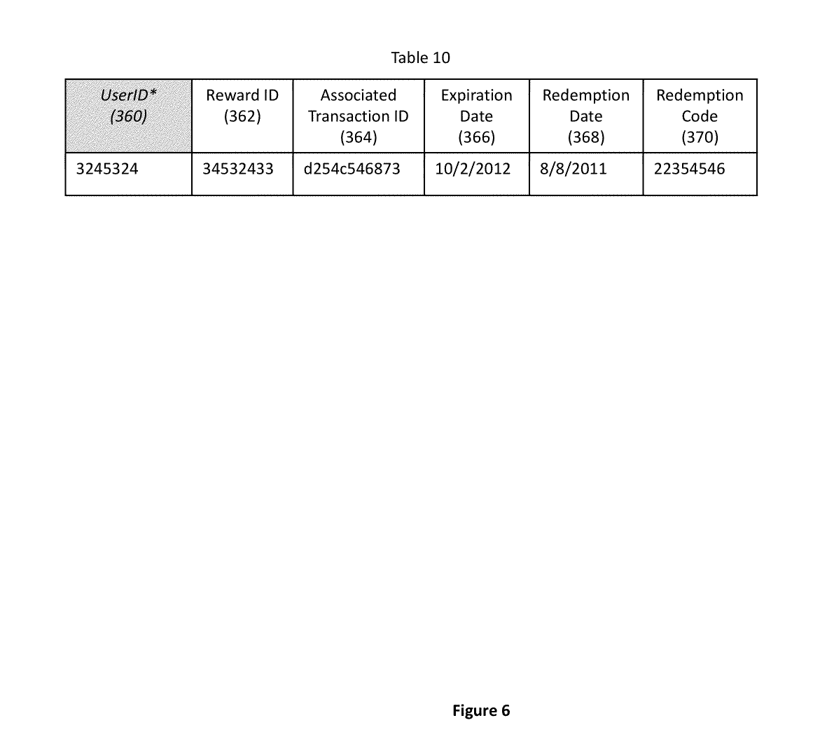

Shown in FIG. 6 is Table 10, which includes exemplary survey participation reward redemption data that is stored in a data storage module. Table 10 includes UserID information 360, survey participation reward identification information 362, survey response transaction identifier information associated with the survey response that triggered issuance of the survey participation reward 364, survey participation reward expiration information 366, survey participation reward redemption timestamp information 368, and information which identifies a redemption entity 370.

Returning to FIG. 2, data storage module 212 is adapted to include or have access to the data structures, databases, and data tables associated with the storage of survey system data described and suggested herein, some of which is illustrated in Tables 1 through 10. In one embodiment, data storage module 212 may include or make use of a commercially available, cloud-hosted database system, such as Oracle. In any event, data storage module 212 may utilize a variety of physical storage mediums to provide the described functionality including, but not limited to, magnetic storage media and optical storage media. In one embodiment, at least a portion of reporting and data storage functionality may be provided by external servers and/or data storage backend platforms. For example, reporting module 206 may communicate and interoperate with an external, cloud-based reporting and database system, such as that provided by SalesForce.com. Likewise, in other embodiments, the various functions described with herein with respect to server application module 202 may be distributed over one or more cloud-based application and/or database server platforms.

According to one aspect, communication module 214 is adapted to facilitate communication with one or more scan-triggered service client modules, as previously described herein. As such, communication module 214 is adapted to interoperate with and generally facilitate communications with scan-triggered service client module 104 via survey client communication module 118. A variety of communication protocol stacks and languages may be implemented by communication module 214 within the scope of the subject matter described herein, including but not limited to, transmission control protocol/Internet protocol (TCP/IP), user datagram protocol/Internet protocol (UDP/IP), Hypertext Transfer Protocol (HTTP), Extensible Markup Language (XML), Hypertext Markup Language (HTML), Simple Object Access Protocol (SOAP), Session Initiation Protocol (SIP), etc.

According to another aspect, communication module 214 is adapted to facilitate communication with a surveying user entity via a communication interface other than survey client-based communication module 118. For example, communication module 214 is adapted to facilitate communications with a web browser (e.g., Chrome, Internet Explorer, FireFox, etc.). Such web browser interface support may be used, for example, by a surveying or user entity to provision survey system information.

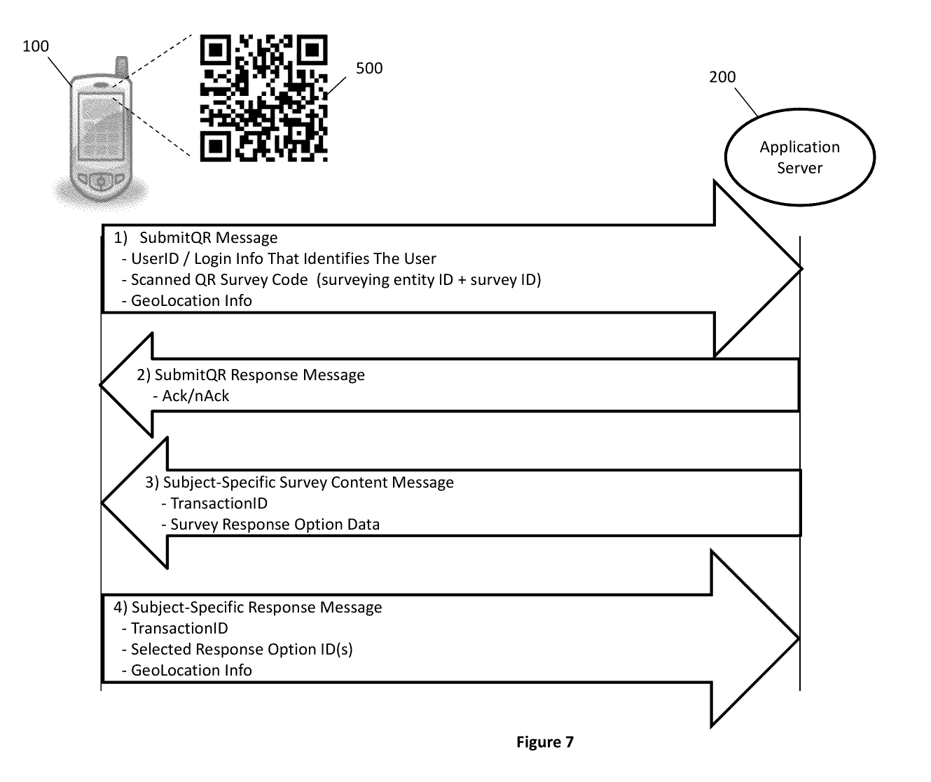

FIGS. 7 through 9 present various exemplary communication/signaling scenarios that may be associated with embodiments of the subject matter described herein. These communication scenarios are not intended to represent all possible information communication scenarios, and are instead merely illustrative in nature.

FIG. 7 includes mobile communication device 100 (e.g., smartphone), which includes a camera module and a scan-triggered service client module previously described herein. Also included is application server 200, which includes a server application module previously described herein. In the exemplary scenario illustrated, smartphone 100 runs, executes, or activates the scan-triggered service client module residing on the device. A user of smartphone 100 navigates within the scan-triggered service menu structure so as to reach a point where the user is prompted to use the associated camera module to scan a subject-specific survey QR code icon 500 that is associated with a surveying entity. In this example, subject-specific survey QR code icon encodes information that identifies a surveying entity (i.e., Luigi's Pizzeria: SurveyingEntityID=001) and a subject-specific survey area (i.e., “Wait Staff Service”: Code 111). The scanned QR code icon is decoded, yielding the code “001111”. The code “001111”, along with current geo-location coordinate information (i.e., Long, Lat, Elev) and information that identifies the user is communicated to application server 200 via SubmitQR message 1. It will be appreciated that in other embodiments, user identifying information may be provided to the application server 200 in a separate message during a manual or automatic user login transaction. Application server 200 acknowledges receipt of the SubmitQR message with a SubmitQR Response message 2. Application server 200 logs and processes the scanned subject-specific survey and surveying entity information provided by the user, and provides subject-specific survey content information in Subject-Specific Survey Content message 3. In this example, Subject-Specific Survey Content message 3 includes a transaction identifier, a subject-specific survey identifier, survey response descriptor information, and response option content. In this example, the transaction identifier is “d254c546873”, the subject-specific survey identifier is “001300”, the survey response descriptors are “Service Was Poor”, “Service Was Great!”, and the response option IDs are “01” and “02”, respectively.

The survey response descriptor and response option content is displayed to the user, who is permitted to select some or all of the response options. For example, the user may use touchscreen capability on the smartphone to select some or all of the displayed response options. Once selection is complete the user, via the scan-triggered service client module user interface, causes the selected response option information to be communicated to application server 200 via Subject-Specific Response message 4. The Subject-Specific Response message includes transaction identifier information and selected response option information, and current geo-location coordinate information (i.e., Long, Lat, Elev). In this example, the transaction identifier is “d254c546873”, the selected response option content includes the following: ReponseOptionID=02−“Service Was Great!”, and current geo-location information includes current Long., Lat., Elev. coordinates. Application server 200 logs the subject-specific survey selected response option information provided by the user. It will be appreciated that application server 200 could provide additional follow-up survey content information via one or more additional Follow-up Survey messages, thereby progressively soliciting more and more specific or targeted feedback from the user following the initial subject-specific QR code scan by the user. The ability to progressively focus the survey content presented to a user following the scanning of a more general but subject-specific QR code-based feedback icon is one of several advantages of the subject matter described herein.

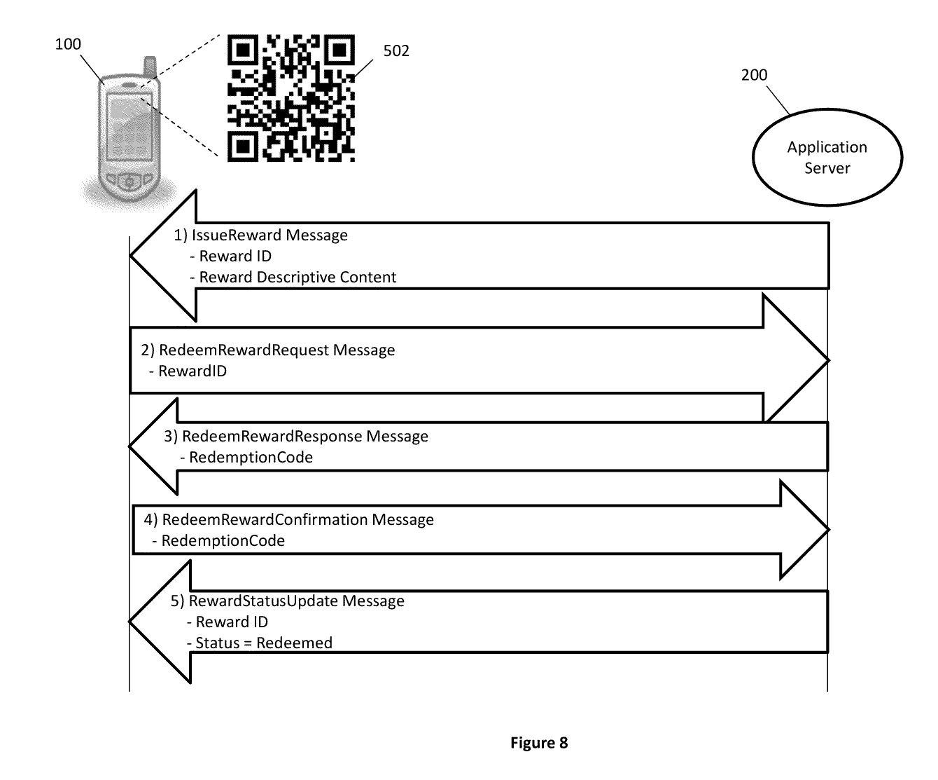

FIG. 8 includes mobile communication device 100 (e.g., smartphone), which includes a camera module and a scan-triggered service client module previously described herein. Also included is application server 200, which includes a server application module previously described herein. In the exemplary scenario illustrated, smartphone 100 runs, executes, or activates the scan-triggered service client module residing on the device. In this operational scenario, application server 200 determines that the user of smartphone 100 has earned or should be distributed a reward, such as a survey participation reward. This could be, for example, the result of the user providing the survey response feedback information described previously with respect to FIG. 7. In one embodiment, the participation reward is selected based, at least in part, on survey subject identification information received by application server 200. In any event, application server 200 communicates an IssueReward message 1 to smartphone 100. IssueReward message 1 includes a survey participation reward identifier and descriptive content associated with the reward. In this example, the survey participation reward identifier is “34532433” and the reward descriptive content is “$2 Off Any Item.” The scan-triggered service client module associated with smartphone 100 receives and stores/caches the survey participation reward information and displays it on-demand to the user. In various embodiments, survey participation reward content may be either “pushed” by application server 200 (such as is described above), or “pulled” by the scan-triggered service client module on smartphone 100 (i.e., the scan-triggered service client module may request that reward content be sent by application server 200).

Continuing with the exemplary operational scenario presented in FIG. 8, the smartphone user navigates within the user interface menu structure provided by the associated scan-triggered service client module on the smartphone so as to reach a point where the user is prompted to select the survey participation reward that is to be redeemed. Once the user has selected the reward that is to be redeemed, the user is prompted to use the associated camera module to scan a redemption QR code icon 502. In this example, redemption QR code icon encodes information that identifies the surveying entity with which the reward is being redeemed (i.e., Luigi's Pizzeria: SurveyingEntityID=001). The surveying entity with which the reward is being redeemed is also referred to herein as the redemption entity. In other embodiments, the redemption QR code could be, for example, a randomly generated code or an arbitrary code selected and provisioned by or for the redemption entity. The scanned redemption QR code icon is decoded, yielding the code “001”. The code “001”, along with the selected survey participation reward identification information RewardID=34532433 are communicated to application server 200 via RedeemRewardRequest message 2. Application server 200 acknowledges receipt of the RedeemRewardRequest message with a RedeemRewardResponse message 3. The RedeemRewardResponse message includes a redemption authorization code, “22354546”, which is displayed to the user. In practice, the redemption entity asks to view the redemption authorization code so as to verify that the reward is valid and has been processed by/is considered redeemed by application server 200. The messaging scenario shown in FIG. 8 assumes that the user takes an action that signals application server 200 with a ReedemRewardConfirmation message, which confirms that the redemption authorization code has been received and used, and at this point the application server 200 considers the reward to have been successfully redeemed/used. However, embodiments of the subject matter described herein may be implemented that do not require such ReedemRewardConfirmation message signaling from the user in order to complete the redemption transaction. In this embodiment, application server 200 considers the redemption transaction complete when the redemption authorization code (i.e., message 3) is successfully received by the scan-triggered service client module on the smartphone. Once the redemption transaction is complete, application server 200 signals the scan-triggered service client module on smartphone 100 with a RemoveRewardRequest message 5, which causes the survey participation reward content associated with the redeemed reward (i.e., RewardID=34532433) to be either marked as “redeemed” or deleted from the smartphone. For example, the reward content associated with RewardID=34532433 is deleted from the survey client data storage module and RewardStatusUpdate message 6 acknowledging the deletion is generated and sent from smartphone 100 to application server 200.

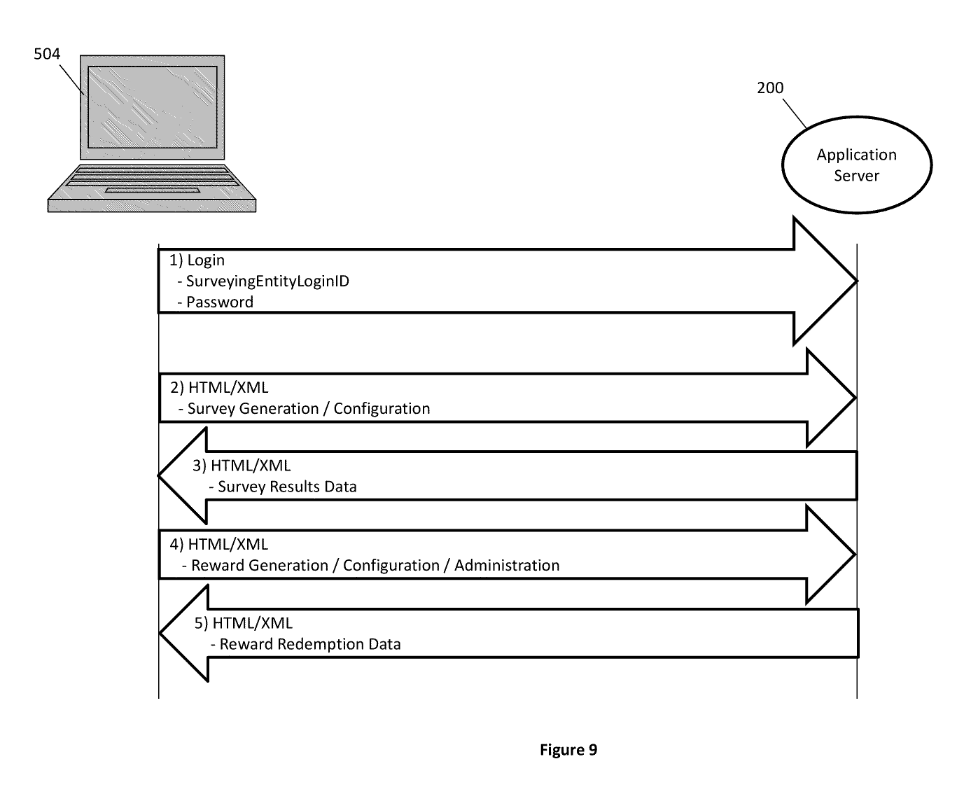

FIG. 9 illustrates an exemplary provisioning and report access scenario. FIG. 9 includes a communication terminal 504, such as a personal computer, tablet computer, netbook computer, laptop computer, mobile computing device, or smartphone that is capable of communicating with application server 200. In one embodiment, communication with application server 200 may be accomplished via a web browser client (e.g., Chrome, Internet Explorer, FireFox) running or executing on communication terminal 504. Communication terminal 504 may utilize a data network (e.g., public Internet, wide area network, mobile data network) to facilitate communication with application server 200. In this example, a surveying entity (or other system provisioner) invokes a web browser on communication terminal 504 and directs the web browser to a uniform resource locator (URL) associated with a server application module hosted on application server 200. The surveying entity submits login credentials, including a username and password via a system Login message 1. Surveying entity is then able to access, provision and configure survey content via message 2. Surveying entity may request and receive reports associated with survey content and survey response data via message 3, which may be generated and sent from application server 200. Surveying entity is able to use this provisioning interface to configure and administer survey participation reward content via message 4. Surveying entity may request and receive reports associated with survey participation reward distribution and redemption data via message 5, which may be generated and sent from application server 200.

Reward Distribution Algorithms

With further regard to the distribution of rewards, it will be appreciated that Reward Control Logic Module 210 may employ various algorithms for specifying the number, type and frequency of reward distribution to users. For example, in one embodiment of the present invention, a new user may be given a reward after submitting a single survey response, whereas a long-time user may be given a reward only after providing multiple survey responses. In another embodiment, a long-time user who has become inactive and not provided survey responses for a prescribed period of time (e.g., has not provided any survey feedback for 2 months) may be given a reward after submitting a single survey response as a means for encouraging use/participation. In other scenarios, reward distribution frequency to a user may be increased (or decreased) as the user increases their frequency of participation.

Detection of Disingenuous Survey Response Feedback

In one embodiment of the present invention, Scan Control Logic Module 208 includes logic that is adapted to monitor responses received from a user and to analyze these responses over time to determine whether the user is attempting to flood the system with minimally useful or disingenuous survey response information. For example, a user may scan multiple survey response QR codes for the same merchant within a short time interval in the hopes of receiving a large number of rewards. Such disingenuous survey responses are counterproductive both from a reward issuance perspective and a qualitative/aggregate survey response statistics perspective (i.e., such frivolous responses do not provide the merchant with meaningful feedback, and make the interpretation of valid responses more difficult). Scan Control Logic Module 208 may employ one or more survey response profiling algorithms to determine whether a user has provided disingenuous survey response information. One exemplary survey response profiling algorithm detects whether one or more duplicate survey response values are provided by a user within a pre-determined time period. Another exemplary survey response profiling algorithm detects whether contradictory survey response values are provided by a user within a pre-determined time period. For example, a user who provides a first survey response value of “Service was good” followed shortly by a second survey response value of “Service was bad” may be flagged as providing disingenuous survey response information. Another exemplary survey response profiling algorithm detects whether the number of survey responses provided by a user with respect to a given merchant during a prescribed time period exceeds a pre-determined threshold value.

In one embodiment, such profiling algorithms are operable to access received survey response information and associated survey response metadata. Exemplary survey response metadata may include, but is not limited to, receipt date- and time-stamp information, information that is indicative of the point-of-scan location (e.g., zipcode, city, state, GPS coordinates, etc.), survey response “demeanor” (e.g., “positive”, “neutral”, “negative”). With regard to survey response demeanor, it will be appreciated that such classification information may be provisioned for each possible survey response during the construction of survey content via provisioning module 204. As such, each possible scan-able survey response may be generally classified according to a particular demeanor values (e.g., “positive”, “neutral”, “negative”). In various embodiments of the present invention, Scan Control Logic Module 208 is adapted to access and analyze received survey response information and associated survey response metadata related to a particular user. Using such survey response information and associated survey response metadata, any number of profiling algorithms may be implemented within the scope of the present invention. As discussed previously, one profiling algorithm involves analyzing survey responses and associated metadata to determine if the number of survey responses received during a prescribed time period (e.g., 5 minutes) exceeds a threshold value. Another exemplary profiling algorithm involves analyzing survey responses and associated metadata to determine if the number of survey responses received during a prescribed time period (e.g., 5 minutes) exceeds a threshold value and whether at least a portion of the received survey responses have conflicting demeanor values.

In response to determining that a user has provided disingenuous survey response information/feedback, Scan Control Logic Module 208 is adapted to take a mitigation action. Exemplary mitigation actions may include, but are not limited to, discarding those survey responses that were deemed to be disingenuous, marking or flagging those survey responses that were deemed to be disingenuous and storing them in data storage module 212, communicating with reporting module 206 and/or reward control logic module 210 (e.g., via the marking or flagging described previously) so that the disingenuous survey responses are not reported or rewarded. A warning message may also be sent to the offending user and/or the user's account may be suspended or terminated.

### Use of OR Code & Cookie to Open Reward Wallet

A special purpose “reward redemption” scan-able code (e.g., QR code) may be generated by provisioning module 204. The reward redemption QR code may include information which is received and interpreted by one or more modules associated with the scan-able survey system of the present invention as a request to display survey participation reward information so that it may be viewed and/or redeemed. For example, the reward redemption QR code icon may include or incorporate a reward redemption command code value (e.g., alphanumeric code) which is resolved and interpreted by the scan-able survey system of the present invention as an instruction to display available survey participation reward information to the user who scans the reward redemption QR code. When scanned by scan-able code reader module 106, the reward redemption command code value incorporated within the reward redemption QR code is extracted and triggers the display of available survey participation reward information to the scanning user. In one embodiment, the filtering and displaying of rewards in the user's reward wallet may be facilitated, at least in part, by reward control logic module 114 and data storage module 116. In another embodiment, the filtering and displaying of rewards in the user's reward wallet may be facilitated, at least in part, by reward control logic module 210 and data storage module 212.

The reward redemption QR code may also include information which identifies a survey client (e.g., business or merchant). The act of scanning the special purpose reward redemption QR code causes the Scan-triggered service client module 104 on the user's mobile device to display the user's rewards/reward wallet. If the scanned reward redemption QR code includes information which identifies a survey client, the specific reward(s) displayed to the user may be those associated with the specified business or merchant. According to one embodiment, when the reward redemption QR code is scanned by Scan-triggered service client module 104, a previously generated cookie (or other login credential data structure/file) that includes user login credentials is accessed. The login credentials may be used to automatically log the user in to an interface (e.g., AAA interface function within communication module 214) associated with Server Application Module 202, so that rewards may be displayed and/or redeemed by the user. In another embodiment, the login credentials may be used to automatically log the user in to an interface associated with Scan-triggered service client module 104, so that rewards may be displayed and/or redeemed by the user.

In cases where the scanned reward redemption QR code includes information which identifies a survey client, the survey client identifying information (e.g., a survey client ID) obtained from the reward redemption QR code scan may be used to select and display those rewards within the user's reward “wallet”. In one embodiment, the filtering and displaying of rewards in the user's reward wallet may be accomplished, at least in part, by reward control logic module 114 and data storage module 116. In another embodiment, the filtering and displaying of rewards in the user's reward wallet may be accomplished, at least in part, by reward control logic module 210 and data storage module 212.

### Scan Triggered Immediate Notification

In one embodiment of the present invention, survey content provisioning module 204 is adapted to permit the association of an immediate notification trigger (INT) with a particular survey response value, such that when the survey response value is received from a user the associated immediate notification trigger is fired. Associated with each INT is a notification message, a notification mode, and a notification contact address. An exemplary notification message may include a text descriptor associated with the triggering survey response value (e.g., “Restrooms are not clean”) or a voice recording of an alert message. Exemplary notification modes may include, but are not limited to, text message, instant message, short message service, tweet, email, and voice call. Exemplary notification contact address information may include, but is not limited to, a mobile subscriber ISDN (MSISDN), a mobile telephone number, an email address, an online user identifier, a uniform resource identifier (URI), a session initiation protocol (SIP) URI, a telephone number, an Internet protocol address, and a Twitter address. In one embodiment, Scan Control Logic Module 208 includes logic that is adapted to monitor responses received from a user and to determine if a received survey response value fires an INT. In response to determining that an INT should be fired, module 208 generates the INT-specified notification message and transmits or causes the notification message to be transmitted to the specified notification contact address. It will be appreciated that more than one notification contact address may be associated with an INT, and consequently multiple notification messages may be generated in response to the firing of a single trigger.

### Survey Response Analytics

According to one aspect of the present invention, Scan Control Logic Module 208 includes logic that is adapted to monitor and record survey responses received from a user, where each survey response is associated with a survey client (e.g., merchant or business). Each survey client is classified according to a pre-defined classification framework. For example, survey client X may be classified as “Restaurant: Table Service: Italian”, survey client Y may be classified as “Physician: Family Practitioner”, etc. Geo-location information (e.g., zip code, city, state, GPS coordinates) for each survey client is maintained/accessible by Scan Control Logic Module 208. Using this information, module 208 is adapted generate a usage profile for the user which reflects survey client usage/patronage patterns. For example, over time, module 208 may monitor and record/store (via data storage module 212) 100 survey responses that are provided by the user, where each response (and associated metadata) is associated with a survey client. Module 208 includes logic that is adapted to analyze the 100 survey responses and determine that the user has repeatedly visited/patronized survey client X and survey client Y in the past 3 months. Based on this usage profile, module 208 is adapted to identify another survey client that has both a similar classification to that of survey client X as well as a similar geo-location. This survey client that has both a similar classification to that of survey client X as well as a similar geo-location is referred to herein as an “introducible” survey client. As the term suggests, an introducible survey client is one that the analytics algorithm or profiling logic associated with module 208 determines may be of interest to the user based on the user's observed usage/patronage patterns. Module 208 may send/trigger/suggest the sending of a message to the user suggesting that the user may want to patronize the similar survey client. Exemplary message content may include, but is not limited to, an advertisement, reward, or coupon. Messages may be communicated to the user and viewed, for example, via Scan-triggered service client module 104 or alternatively via email, text messaging service, instant messaging service, Twitter, direct mailing, or other communication means.

### Reward Sharing

In one embodiment, module 210 may facilitate the sharing, gifting, or transfer of a survey participation reward from one user to another user. In this case, a first user who is the current owner of a survey participation reward, selects the reward and identifies a second user to whom the reward is to be transferred. The first user then communicates information that identifies both the reward and the “transferred to” user to module 210. The information that identifies the “transferred to” or recipient user may be a username or user ID provided by the recipient user at the time of registration by the recipient user. Module 210 receives, processes and logs the transfer request and updates the appropriate reward data so as to execute the transfer. In one embodiment, reporting module 206 enables a client entity or user to view, track and analyze such reward transfers. In various embodiments of the present invention, restrictions/limitations/qualifications may be imposed on rewards that are to be transferred or gifted from one user to another. For instance, module 210 may include reward transfer or gifting rules that specify those conditions under which a reward may be transferred and/or those conditions under which a reward may not be transferred. These rules may be stored in a database, table, or data structure that is contained within or accessible by module 210. An exemplary rule may state that a reward may only be transferred or gifted to a new user (e.g., a user that has registered for service, within the past 30 days, etc.). In order to enforce this rule module 210 may access user registration data that is maintained in data storage module 212. Another exemplary rule may state that a reward may only be transferred or gifted to a user who has not previously patronized the survey client with which the reward is associated. In order to enforce this rule module 210 may access user survey response data that is maintained in data storage module 212.

In one embodiment, an existing user may transfer or gift a reward to an individual who has not yet become a registered user. To facilitate such a special transfer, the existing user communicates information that identifies both the reward and the “transferred to” or recipient user to module 210. In this case, since the recipient user is not yet a registered user of the system/service, the existing user must specify a public contact address for the intended recipient. Exemplary public contact addresses may include, but are not limited to, an email address, a mobile telephone number, a mobile subscriber ISDN (MSISDN), a Twitter address, an instant message address. Module 210 receives processes and logs the transfer request. In one embodiment, module 210 is adapted to generate a message that is addressed to the specified public contact address (e.g., email address). In one embodiment, the message may include the transferred reward or information specifying how the transferred reward may be obtained and redeemed. In another embodiment, the message may include information that describes the pending reward transfer and also provides a hyperlink/URL associated with a WEB page where the intended recipient may register and thereby receive and redeem the transferred reward. The existing user that transferred or gifted the reward (thereby resulting in the recruitment/registration of a new subscriber) may be issued a new reward as a result of the transfer. The new reward may be the same as the transferred reward or different. The new reward may be issued by reward control logic module 210.

Dynamic Reward Values

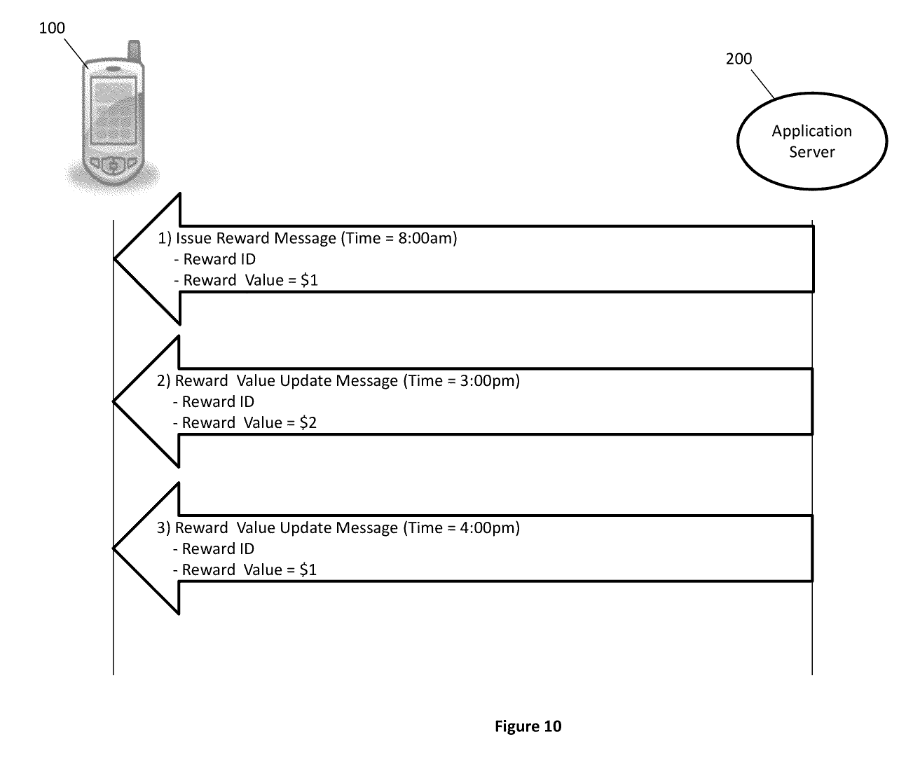

In one embodiment of the present invention, a mobile user may scan a survey response QR code using, for example, a scan-triggered service client module associated with a smartphone in a manner similar to that previously described herein. Scan-triggered application system service code information (e.g., survey response identifier information, contact list identifier information, event invitation identifier information, etc.), such as a survey response code information associated with the scanned survey response QR code is communicated to an application server module, in a manner that is similar to that previously described, and in response to receiving the scanned survey response code information, Reward Control Logic Module 210 is adapted to grant the mobile user an digital coupon or reward. It will be appreciated that such a digital reward may, in general, be communicated from application server 200 to mobile communication device 100 using an number of communication/application protocols, such as hypertext transfer protocol (HTTP), etc. As generally illustrated in FIG. 10, step 1, a reward may be granted at a first time (e.g., time=8:00 am) which has an associated base value. Examples of a base value include an explicit cash value (e.g., $1 off next purchase), a percentage discount (e.g., 5% off next purchase), and other quantitative values that can be used to obtain a good or a service. In one exemplary embodiment, the reward is granted to the mobile user and credited to the user's account at or near the time that the scanned survey response information is received by the application server module. For example, the mobile user's account is credited with a “$1 Off” reward in response to the scanning of a survey response QR code on Monday at 8:00 am. After the reward is credited to the user's account, the user may access and redeem the reward at any time. An exemplary reward redemption process is previously described herein. According to one aspect of the present invention, at some second time following the granting of the reward but prior to redemption of the reward, the value of the reward may be altered, as indicated in step 2. For example, in one embodiment, Reward Control Logic Module 210 is adapted to increase the value of the granted reward from the base or initial “grant-value” of “$1 Off” to “$2 Off” on Tuesday at 3:00 pm. Consequently, if the reward is redeemed by the mobile user on Tuesday, its redemption value will be “$2 Off.” Continuing with this example, if the mobile user does not redeem the reward on Tuesday, Reward Control Logic Module 210 is adapted to decrease the value of the reward, for example, back to the original base or “grant-value” on Wednesday at 4:00 pm, as indicated in step 3. This process may be repeated multiple times for a reward over many days or months until the reward is either redeemed, expires, or withdrawn. This process of dynamically altering reward values is referred to herein as “Reward Popping™.” It will be appreciated that the time interval associated with such dynamic reward value alterations may vary over any range of times. For example, a reward may be “popped” and dynamically altered from a value of “$1 Off” to “$2 Off,” and remain at the “$2 Off” value for 10 minutes, or the reward may remain at the higher value for 10 days, or the reward may remain at the higher value until redemption or expiration.

Various algorithms may be implemented by Reward Control Logic Module 210 to determine which rewards are to be dynamically altered as previously described. Reward Control Logic Module 210 may also determine which user's rewards are to be dynamically altered, and when the alterations are to occur. For example, in one embodiment, Reward Control Logic Module 210 may examine a dynamic alteration flag that is set or cleared at the time of a reward's provisioning to determine whether the reward's value should or may be dynamically altered. Reward Control Logic Module 210 may examine one or more reward campaign liability parameter values which may be specified at the time of a reward's provisioning to determine the total number of granted rewards that may be altered and the corresponding amounts by which these granted reward values may be altered. At the time of provisioning a total cash liability may be specified for a reward which indicates the largest outstanding cash liability associated with the reward that a merchant is willing to accept or be liable for during the distribution period of this reward. For example, at provisioning time, a maximum cash liability value of $500 may be specified for the “$1 Off” reward campaign. This means there should not be more than 500 rewards distributed during this reward campaign, since each represents a potential cash liability of $1 once distributed. In one embodiment of the present invention, a “pop value” may also be specified. In this case, the specified pop value may be used in conjunction with the specified maximum cash liability value to determine how many/which rewards may have their values altered and by how much. For example, if the maximum cash liability value specified is $500 and the pop value specified is $250 and there are 500 outstanding/granted rewards, then 250 of the outstanding rewards may be selected by Reward Control Logic Module 210 and their values may each be increased by $1, so that the selected rewards now have a value of “$2 Off.” Alternatively, Reward Control Logic Module 210 could select all 500 of the outstanding rewards and their values may each be increased by $0.50, so that the selected rewards now have a value of “$1.50 Off.” It will be appreciated that any number of algorithms may be implemented to facilitate the “popping” or dynamic alteration of reward values within the provisioned total outstanding value liability constraints. Continuing with the above example, it will again be appreciated that Reward Control Logic Module 210 may subsequently alter the values of the selected set of rewards in a manner that reduces their value. For instance, the values of those rewards that were previously “popped” to “$2 Off” may, after some time, be reduced back to the base or original grant-value of “1$ Off.”

Given an outstanding pool of granted rewards that are eligible to have their values dynamically altered, Reward Control Logic Module 210 may, for example, select the rewards from the eligible pool using a random selection algorithm. In other exemplary embodiments, rewards may be selected for dynamic alteration based, at least in part, on the prior survey response histories of the user's to which they were granted, or based, at least in part, on user gender, or based, at least in part, on user age, or based, at least in part, on user location, or based, at least in part, on date/time, or other selection criteria. For example, the 250 users that have been the most frequent survey respondents over the past 6 months may be preferentially selected for a dynamic alteration of each of their granted reward values, while the remaining 250 users that have been granted the same reward do not have the value of their rewards dynamically altered. It will be appreciated that any number of alternate user/reward selection algorithms may be implemented within the scope of the present invention. The two shown here are merely illustrative of the types of selection algorithms that may be implemented by Reward Control Logic Module 210.

In one embodiment of the present invention, once a reward that has been granted to a user has its value dynamically altered, the user may be notified or otherwise made aware of the fact that a dynamic alteration has occurred. For example, Reward Control Logic Module 210 may be adapted to trigger the generation and communication of a message to the user that serves to notify the user of the fact that a dynamic alteration has occurred. Notification may, for instance, take the form of an email message, a text message, an instant message, a Tweet®, a Facebook® post, or a communication that is internal to the scan-able survey and reward distribution system/platform that is described in various embodiments herein. With regard to the later, in one embodiment, when granted rewards are viewed via a reward viewing interface (e.g., reward, “wallet”), a reward that has had its value dynamically altered may be visually highlighted or categorized/sorted in a way that indicates or suggests that its current value is the result of a dynamic value alteration. In this way, a user can quickly determine which of their granted rewards have values that are currently dynamically altered. In one embodiment, an indication of how long the reward value will remain altered may also be provided to the user.

Accordingly, embodiments of the present invention include a system for distributing digital rewards associated with the scanning of survey scan codes, the system comprising:

a computing platform including a processor:
a server application module executable by the processor and configured to:
receive scanned survey response information communicated by a scan-triggered service client module;
in response to receiving the scanned survey information, grant a reward with an associated first value to a user at a first time; and
at a second time, alter the worth of the reward to a second value.
   In various embodiments, the scan-triggered service client module may reside on a mobile communication device.
   In various embodiments, altering the worth of the Reward to a second value includes increasing the value of the Reward.
   In various embodiments, at a third time, the worth of the Reward is adjusted to a third value which is less than the second value.
   Furthermore, embodiments of the present invention include a method for distributing digital Rewards associated with the scanning of survey scan codes, the method comprising: at a server application module;
receiving scanned survey response information communicated by a scan-triggered service client module;
in response to receiving the scanned survey information, granting a Reward with an associated first value to a user at a first time; and
at a second time, altering the worth of the Reward to a second value.
   In various embodiments, the scan-triggered service client module includes a scan-triggered service client module residing on a mobile communication device.
   In various embodiments, altering the worth of the Reward to a second value includes increasing the value of the Reward.
   In various embodiments, at a third time, the worth of the Reward is adjusted to a third value which is less than the second value.

Reward Cloning™

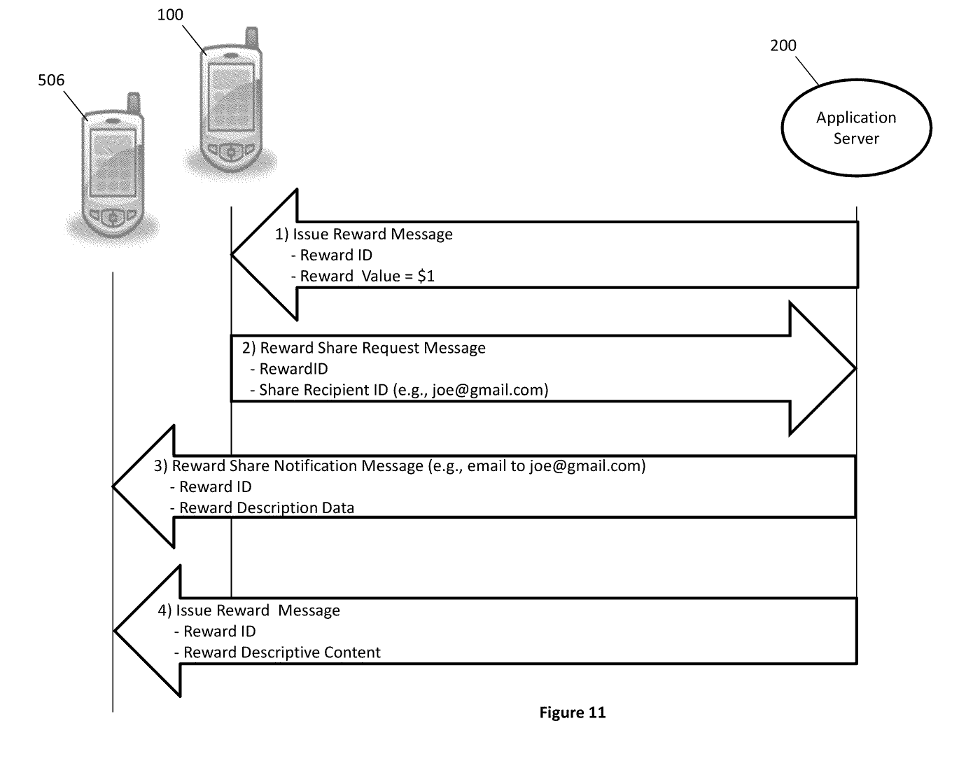

In one embodiment of the present invention, a mobile user may scan a survey response QR code using, for example, a scan-triggered service associated with a smartphone in a manner similar to that previously described herein. Survey response information associated with the scanned survey response QR code is communicated to an application server module, in a manner that is similar to that previously described, and in response to receiving the scanned survey response information, Reward Control Logic Module 210 is adapted to grant the mobile user an digital coupon or reward. As generally illustrated in FIG. 11, step 1, a reward that has an associated base value may be granted to a user. Examples of a base value include an explicit cash value (e.g., $1 off next purchase), a percentage discount (e.g., 5% off next purchase), and other quantitative values that can be used to obtain a good or a service. In one exemplary embodiment, the reward is granted to the mobile user and credited to the user's account at or near the time that the scanned survey response information is received by the application server module. For example, the mobile user's account is credited with a “$1 Off” reward in response to the scanning of a survey response QR code on Monday. After the reward is credited to the user's account, the user may access and redeem the reward at any time. An exemplary reward redemption process is previously described herein. According to one aspect of the present invention, at some time following the granting of the reward, the mobile user may submit a request via their smartphone-based scan-triggered service client module 104 to server application module-based Reward Control Logic Module 210 create a copy of or “clone” the reward which is to be shared with another user (step 2). In one embodiment of the present invention, the clone request includes information that identifies the requesting or “sharing” user (e.g., the user's ID), the reward (e.g., a Reward ID), and one or more intended recipients of the reward clones. Exemplary clone recipient identifying information may include, but is not limited to, an email address, a Twitter® address, a Facebook® account identifier, a text message service address (e.g., mobile telephone number), an instant message address, a user identifier or address that is internal to the scan-able survey and reward distribution system/platform (e.g., a Flashback™ user ID). In one embodiment, once received by Reward Control Logic Module 210, the share or clone request is treated as “pending.” Using the provided Reward identifier, the client entity (e.g., business owner or merchant) associated with the reward is determined. The associated client entity (i.e., the entity that issued the original reward) is notified of the pending reward cloning request. Client entity notification may, for instance, take the form of an email message, a text message, an instant message, a Tweet®, a Facebook® post, or a communication or posting that is internal to the scan-able survey and reward distribution system/platform that is described in various embodiments herein. For example, log-in to the client entity's account may cause a pop-up window to appear which provides notification of the pending clone request. The pop-up notification window may provide options for the client entity administrator (e.g., store manager, etc.) to approve or decline the pending reward cloning request. If the pending reward cloning request involves the creation of more than one copy of the reward, the pop-up notification window may provide options for the client entity administrator to approve or decline each clone or copy separately. For example, if a reward clone request is received that involves the creation of 5 copies or clones of the reward, the client entity administrator may choose to approve only 3 of the 5 requested copies. In general, the client entity administrator may approve or decline some, all or none of the clone copies associated with a reward clone request. In an alternate embodiment, the client entity administrator may receive an email message that includes a uniform resource locator (URL) link that may be clicked to approve the reward clone request, and/or a URL link that may be clicked to decline the reward clone request.

In an alternate embodiment, Reward Control Logic Module 210 may assume responsibility for approving or declining some, all or none of the clone copies associated with a reward clone request without interactive/real-time input from a client entity administrator. Such “automatic” determination may be made, for example, based on the current total un-redeemed, un-expired distribution of that reward, which is related to the total outstanding liability associated with that reward. For example, if the reward (e.g., “$1 Off”) associated with a reward cloning request has been provisioned with a maximum cash liability value of $500, this means there should not be more than 500 rewards distributed during this reward campaign, since each represents a potential cash liability of $1 once distributed. Assume that 300 of these rewards have been distributed, and a reward cloning request is received for this reward, requesting that 5 copies or clones be made and distributed. Reward Control Logic Module 210 may determine that there is currently an outstanding liability of $300, and make the decision to approve all 5 of the clone copies since this would result in a new total outstanding liability of $305, which is less than the $500 maximum.

In the event that a reward cloning request is approved and the cloned reward recipient is a registered user of the scan-able survey and reward distribution system, then the cloned reward is credited to the account of the cloned reward recipient user 506 and may be redeemed. The cloned reward recipient user may also be notified of the granting of the cloned reward. These operations are generally illustrated in steps 3 and 4. In the event that a reward cloning request is approved and the cloned reward recipient is not a registered user of the scan-able survey and reward distribution system, then a message may be generated and sent to the potential cloned reward recipient, informing the potential recipient of the pending reward grant. Once the potential recipient registers as a user of the scan-able survey and reward distribution system, then the cloned reward is credited to their and may be redeemed.

It will be appreciated that a key distinction between reward “sharing” and reward “cloning” is that, in the case of cloning, the mobile user that submits the reward cloning request retains the original reward and may redeem it. In the case of reward “sharing”, the mobile user that shares their reward with another user is in effect giving the other user their reward.
Accordingly, embodiments of the present invention include a system for distributing digital rewards associated with the scanning of survey scan codes, the system comprising:
a computing platform including a processor:
a server application module executable by the processor and configured to:
   receive scanned survey information communicated by a scan-triggered service client module associated with a user;
   in response to receiving the scanned survey information, grant a Reward to the user;
   receive a request from the user to clone the reward, where the cloned copy of the Reward is to be provided to a recipient;
   generate a cloned copy of the Reward; and
   provide the cloned copy of the Reward to the recipient.
In various embodiments, the server application module may be configured to receive, from the scan-triggered service client module, user identification credential information previously stored by the scan-triggered service client module.
In various embodiments, the scan-triggered service client module may reside on a mobile communication device.
In various embodiments, the server application module may request authorization for the Reward cloning prior to generating the cloned copy of the Reward.
In various embodiments, providing the cloned copy of the Reward to the recipient includes notifying the Reward recipient of the cloned reward.
Furthermore, embodiments of the present invention include a method for distributing digital Rewards associated with the scanning of survey scan codes, the method comprising:
at a server application module;
   receiving scanned survey information communicated by a scan-triggered service client module associated with a user;
   in response to receiving the scanned survey information, granting a Reward to the user;
   receiving a request from the user to clone the Reward, where the cloned copy of the Reward is to be provided to a recipient;
   generating a cloned copy of the Reward; and
   providing the cloned copy of the Reward to the recipient.
In various embodiments, the scan-triggered service client module resides on a mobile communication device.
In various embodiments, the server application module may request authorization for the Reward cloning prior to generating the cloned copy of the Reward.
In various embodiments, providing the cloned copy of the Reward to the recipient includes notifying the Reward recipient of the cloned Reward.

FlashVote™

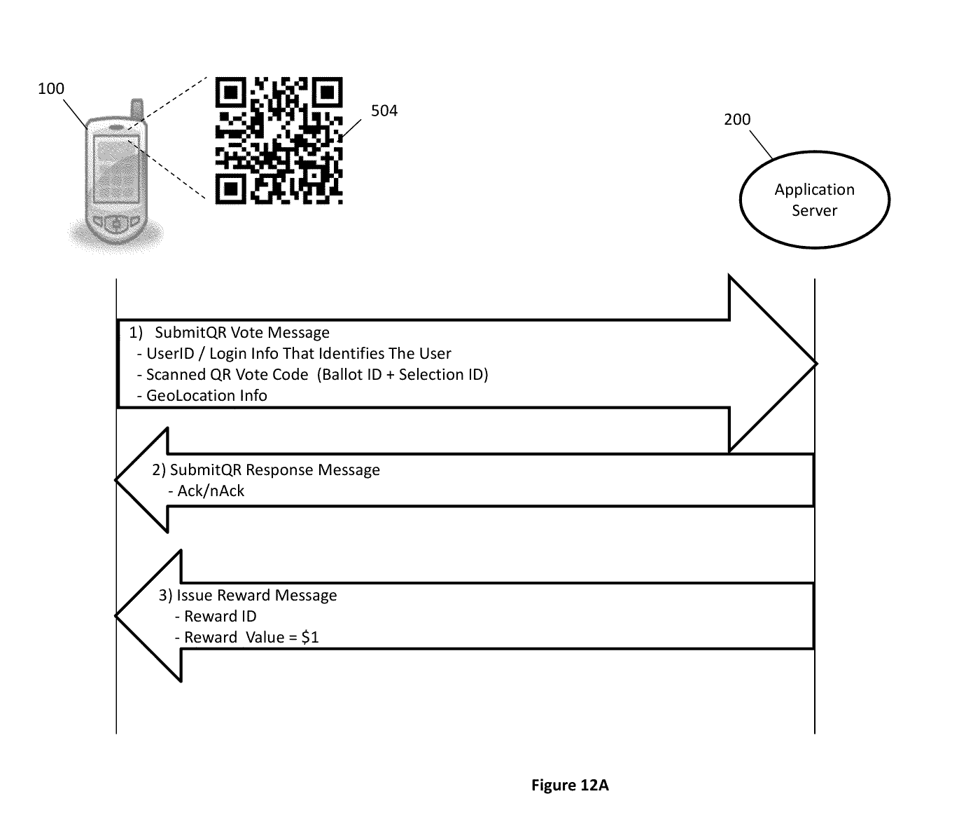

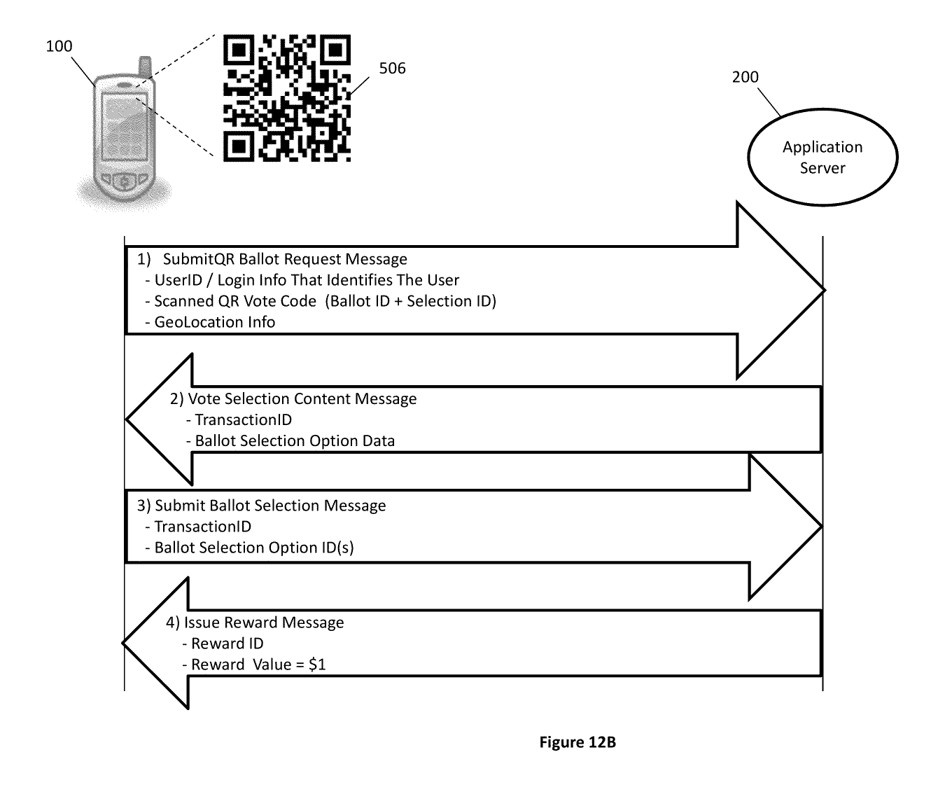

In one embodiment of the present invention, a mobile user may scan a survey response QR code using, for example, a scan-triggered service client module associated with a smartphone in a manner similar to that previously described herein. A group of scan-able response codes are provisioned in the scan-able survey response system (as generally described previously in this disclosure) and are logically grouped together so as to form a ballot. In one embodiment, a ballot identifier, which uniquely identifies the ballot, is associated with each of the scan-able response codes in the group that comprise the ballot. Each of the scan-able response codes in the ballot group is associated with a vote selection option. For example, as generally illustrated in FIG. 12A, a ballot may be defined as “Presidential Candidates.” Two scan-able survey response codes may be generated, where the first survey response code 504 represents the ballot vote selection option “Thomas Jefferson,” and the second survey response code represents the ballot vote selection option “John Adams.” In one embodiment, the response information encoded in each of the survey response scan codes can be used to uniquely the ballot and the respective vote selection option. For instance, the response information encoded in the first survey response code identifies the ballot (i.e., effectively serves as a ballot ID) as being the “Presidential Candidates” ballot, and the vote selection as “Thomas Jefferson.” When, for example, the scan-able survey response code associated with the first vote selection option is scanned by a user, the encoded ballot and vote selection identifying information is decoded and sent to an application server module, in a manner that is similar to that previously described, where the ballot vote is processed and a vote for “Thomas Jefferson” is tallied (step 1). In one embodiment, information which can be used to identify the scanning user or scanning user's scanning device (e.g., smartphone, tablet computer, etc.) is also made available to the server application module. For example, registered user login credentials which can be used to identify the user may be automatically provided to the server application module (e.g., via a previously stored login cookie on the user's mobile communication device), or the scanning user may be asked to enter an email address with which the scanned ballot/vote selection information will be associated. Alternatively, Internet protocol (IP) address or static device identifier (e.g., International Mobile Equipment Identifier, etc.) associated with the scanning device may be communicated to or made available to the server application module, which may then be associated with the scanned ballot/vote selection information. For example, module 216 may create and store a binding record that includes user identifying information and vote selection information. This binding record may also include vote selection receipt timestamp information. In response to receiving the scanned ballot and vote selection identifying information, Vote Control Logic Module 216 (shown in FIG. 2) processes the received vote information. As indicated in step 2, a vote receipt confirmation or acknowledgement message/information may be returned to the scanning user. In one embodiment, Vote Control Logic Module 216 is adapted to examine the received ballot vote selection and, in the absence of user identifying information, record and store the ballot vote. In this way, multiple ballot votes resulting from the scanning of multiple survey response or “ballot vote” QR codes may be tallied and reported by a scan-able survey system of the present invention. In another embodiment, Vote Control Logic Module 216 is adapted to examine the received ballot vote selection information and, in the absence of user identifying information, categorize the received ballot vote as “anonymous.” Anonymous ballot votes may be tallied (e.g., recorded) and reported separately from those ballot votes received from identifiable users. In another embodiment, Vote Control Logic Module 216 is adapted to examine the received ballot vote selection information and, in the absence of user identifying information, discard the received ballot vote. In another embodiment, Vote Control Logic Module 216 is adapted to examine the received ballot vote selection information and determine if information that can be used to identify the associated user is present. In one embodiment, if the user identifying information is present/available, Vote Control Logic Module 216 is adapted to record and store the ballot vote as well as information that identifies the user with no regard to the user's voting history. For example, if the user has already cast a vote for the same ballot, multiple (and possibly different) ballot votes will be recorded (and time-stamped) for the user. In another embodiment, if the user identifying information is present/available, Vote Control Logic Module 216 is adapted to determine whether the identified user has previously scanned a vote selection code associated with the same ballot. In response to determining that the user has previously scanned a vote selection code associated with the same ballot, Vote Control Logic Module 216 is adapted to take a vote resolution action. For example, in one scenario, a vote resolution action may include discarding the received ballot vote associated with the user. Alternatively, in response to determining that the user has previously scanned a vote selection code associated with the same ballot, Vote Control Logic Module 216 is adapted to take a vote resolution action which causes the second vote selection to replace the user's previous ballot vote with the received ballot vote. In the later two embodiments, only one vote per ballot is retained/stored for the user. In various embodiments of the present invention, the scan-able survey system may implement one or more voting rules, which for example, may establish a sampling window of time during which votes associated with a ballot may be received, processed and recorded. Voting results for the ballot may be tabulated and reported based on the sampling window during which the votes were received and processed. For example, a first sampling window for a ballot may be open from Jul. 1, 2013 to Jul. 10, 2013. All vote scans received during that period will be tallied and reported. A second sampling window for the same ballot may be opened on Aug. 1, 2013 and closed on Aug. 10, 2013, where all vote scans received during the second period are tallied and reported separate from those received during the first period. In this way, temporal trends in voting patterns associated with the same ballot may be tracked and reported by embodiments of the present invention.

Embodiments of the scan-able ballot voting system described above may include Reward distribution and redemption functionality similar to that previously described in this disclosure. As such, a participation Reward may be distributed to a user that scans one or more scan-able ballot vote selection QR codes, as indicated in step 3. Exemplary voting participation Reward distribution and redemption processing may be facilitated by implementations of a Reward Control Logic Module similar to those previously described.

Illustrated in FIG. 12B is an embodiment where the scan code 500 is encoded with information that identifies a voting ballot, but not a specific ballot response option. As such, when a user scans code 506 (step 1), information that identifies the user and the ballot is communicated to server 200. In step 2, server 200 responds to the user with selectable ballot response option information, which is displayed to the user on their mobile communication device. Exemplary selectable ballot response options might include for example, “Thomas Jefferson” and “John Adams.” In one embodiment, these response options are displayed on the user's mobile screen as touch or tap selectable response options. When the user selects one (or more) of the displayed response options, response option selection information is communicated to server 200, as indicated in step 3. As described with respect to the previous embodiment, vote selection information may be stored for the user in the form of one or more vote binding records in an associated vote tally data structure, and a participation reward may be granted to the user (step 4).

Accordingly, embodiments of the present invention include a system for collecting voting information using scan-able survey codes, the system comprising:
a computing platform including a processor:
a server application module executable by the processor and configured to:
receive first vote selection information from a scan-triggered service client module, where the first vote selection information was obtained from the scanning of a first scan-able vote selection code by a user and where the first scan-able vote selection code is associated with a ballot of possible voting selections; and
use at least a portion of the first vote selection information and associated information that identifies the user to record the user's vote for the ballot as the first vote selection.
   In various embodiments, the server application module is configured to receive, from the scan-triggered service client module, user identification credential information previously stored by the scan-triggered service client module.
   In various embodiments, the server application module is configured to receive second vote selection information from a scan-triggered service client module, where the second vote selection information was obtained from the scanning of a second scan-able vote selection code by the user, and where the second scan-able vote selection code is associated with the ballot and in response to determining that the first vote selection and the second vote selection are not the same, taking a vote resolution action
   In various embodiments, the vote resolution action includes changing the user's recorded vote from the first vote selection to the second vote selection.
   In various embodiments, the vote resolution action includes ignoring the second vote selection.
   In various embodiments, receiving first vote selection information from a scan-triggered service client module includes receiving information that can be used to identify an associated client entity.
   In various embodiments, receiving first vote selection information from a scan-triggered service client module includes receiving information that can be used to identify the associated ballot.
   In various embodiments, user identifying information is also communicated to the server application module via the scan-triggered service client module.
   In various embodiments, the first vote selection information includes information that identifies a client entity.
   In various embodiments, the first vote selection information includes information that identifies the ballot.
   In various embodiments, in response to receiving the first vote selection information, the server application module is adapted to issue a Reward to the user.

Contact List Builder

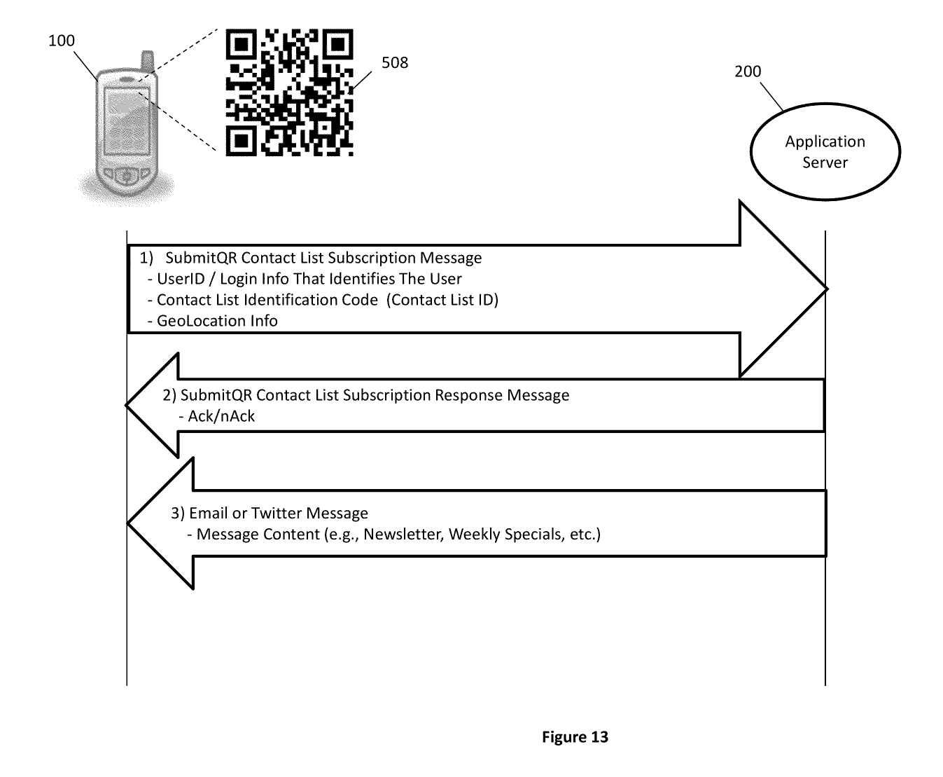

According to one embodiment of the present invention, a scan-able code is generated which, when scanned by a mobile scanning device (e.g., QR code scanner on a smartphone, Near Field Communication scanner on smartphone, a Radio Frequency Identification (RFID) on a smartphone, etc.) associated with a survey system user is adapted to cause a client survey module 104 to communicate contact list subscription request information to server application module 202 which causes the survey system user to be signed-up or registered to receive subsequent communications via a communications medium such as email, text message service, Twitter, Facebook, or other social media communication pathways. Such scan codes are referred to herein as contact list subscription (CLS) scan codes. As generally illustrated in FIG. 13, upon the scanning of a CLS scan code 508, client survey module 104 is adapted to extract information from the scan code that is sufficient to identify a particular contact list to which the user is to be subscribed. In this example, module 104 communicates the obtained contact list identification information (e.g., contact list ID) and other CLS service related information which may include, but is not limited to, information that identifies the business or other entity with which the contact list is associated (e.g., Fred's Coffee Shop, etc.) to the server application module 202, as indicated in step 1. In one embodiment, information that identifies the user that scans the code is communicated to the server application module 202. In various implementations, user information may be provided to server application module at the same time, before, or after the business or other entity identifying information. For example, when a smartphone user scans the CLS code, information which can be used to identify the user's account with the survey system is obtained from a cookie which was previously stored on the user's smartphone. The user identifying information is provided by client survey module 104 to server application module 202 via a mobile Internet connection, for example. In the case where a smartphone user scans the CLS-related QR code and a cookie is not found on the smartphone or the cookie does not contain the necessary user identifying information, the scanning user may be prompted to enter the appropriate login/survey system account credential information (e.g., username and password) and it is at this point that the user's account credential information is effectively provided to server application module 202. If the smartphone user is not a registered user of the survey system service, the user may be prompted to enter survey system account registration/new user credential information, and is at this point that the user's account credential information is effectively provided to server application module 202.

Once the CLS scan and user identifying information is received at server application module 202, an acknowledgement message (step 2) may be returned to the scanning user, and data storage module 116 is adapted to add an identifier associated with the user to a contact list data structure associated with the business entity. In one embodiment, a binding record is generated and stored which associates the user and the identified contact list. In one embodiment, multiple different contact list data structures may be associated with the same business entity. For example, there may be an email contact list data structure and a Twitter contact list data structure. A user associated with an email contact list may receive email messages from the associated business entity, as indicated in step 3. A user associated with a Twitter contact list may receive Tweet messages from the associated business entity. In practice, the user identifying information stored in the contact list data structure may be the user's contact address (e.g., email address, Twitter handle) or may be an alias identifier associated with the user, which is used to access a another data structure within the system to obtain the user's contact address.

In another embodiment, a variant of CLS functionality described above can be used to build a list of potential study patients for a clinical drug trial. In this case, the CLS scan code may be configured to include information that identifies or can be used to identify a clinical trial study coordinating entity (e.g., a contract research organization, a pharmaceutical company, etc.), a clinical trial study, and a referring entity such as a physician, a medical practice, a hospital, an insurance company, a dentist, a dental practice, etc. When the CLS code, such as a QR code, is scanned by a user with their smartphone, client survey module 104 communicates the scanned CLS service related information which may include, but is not limited to, information that identifies the clinical trial study coordinating entity, the clinical trial study, and the referring entity to the server application module 202. Information that identifies the user that scans the code is communicated to the server application module 202 in a manner similar to that previously described. Once the CLS scan and user identifying information is received at server application module 202, data storage module 116 is adapted to add an identifier associated with the user to a clinical trial contact list data structure associated with the identified clinical trial study coordinating entity. In other embodiments, the clinical trial contact list data structure may not be associated with a clinical trial study coordinating entity, but instead with a referring entity. As such various implementations of the clinical trial CLS may simply be used to construct a list of users who would be interested in participating in a clinical trial. Such a contact list may then serve as a recruiting list for one or more clinical trial studies that are being administered by a pharmaceutical or contract research organization.

To facilitate such contact list subscriptions, data storage module 212 may include one or more data structures that contain email address, Twitter handle, text message address, mobile phone number, instant message address and other contact address identifiers associated with survey system users (i.e., those who provide survey response information by scanning a scan code). This contact data may be accessed by various modules of server application module 202 to facilitate the contact list subscription functionality described above.

In one embodiment of the present invention, the commercial entity associated with a contact list (e.g., Joe's Coffee Shop) does not have direct access to the contact address information of the users that have subscribed to the associated contact list via the scanning of a contact list subscription code. As such, the business entity may provide the survey system with the contents of a message that they would like to have distributed to all of the subscribers/members of that contact list. Server application module 202 is adapted to access subscriber contact address information (e.g., email address, Twitter Handle, etc.) from data storage module 212 and generate/distribute messages to each of the contact list subscribers that include the provided message contents. As such, the contact addresses of users remain private to the survey system.

Accordingly, embodiments of the present invention include a system for subscribing a user to a contact list using information obtained from the scanning of a scan-able code using a scan-triggered service client module, the system comprising:
a computing platform including a processor:
a server application module executable by the processor and configured to:
receive, from the scan-triggered service client module, information which can be used to identify a contact list to which the user is to be subscribed where the information is obtained from the scanning of a scan-able code;
receive, from the scan-triggered service client module, user identification credential information previously stored by the scan-triggered service client module; and
in response to receiving the information which can be used to identify the contact list to which the user is to be subscribed and user identification information, associate the user with a contact list.
   In various embodiments, the server application module is also configured to generate a message associated with the contact list and transmit the message to the user associated with the contact list.
   In various embodiments, the server application module is also configured to, in response to receiving the contact list subscription request and user identification information, issue a Reward to the user.
   In various embodiments, the message is one of an email message, a text message, an instant message, a Tweet.
   In various embodiments, the scan-triggered service client module resides on a mobile communication device.
   In various embodiments, the server application module is also configured to receive message content information from a commercial entity associated with the contact list and distribute the message content to the user on behalf of the commercial entity.
   In various embodiments, associating the user with a contact list includes associating the user with a list of users that have agreed to receive periodic communications from an entity associated with the contact list.
   In various embodiments, associating the user with a contact list includes associating the user with a list of users that have expressed an interest in participating in a clinical trial for a drug or medical device.

Reward Expiration Extension

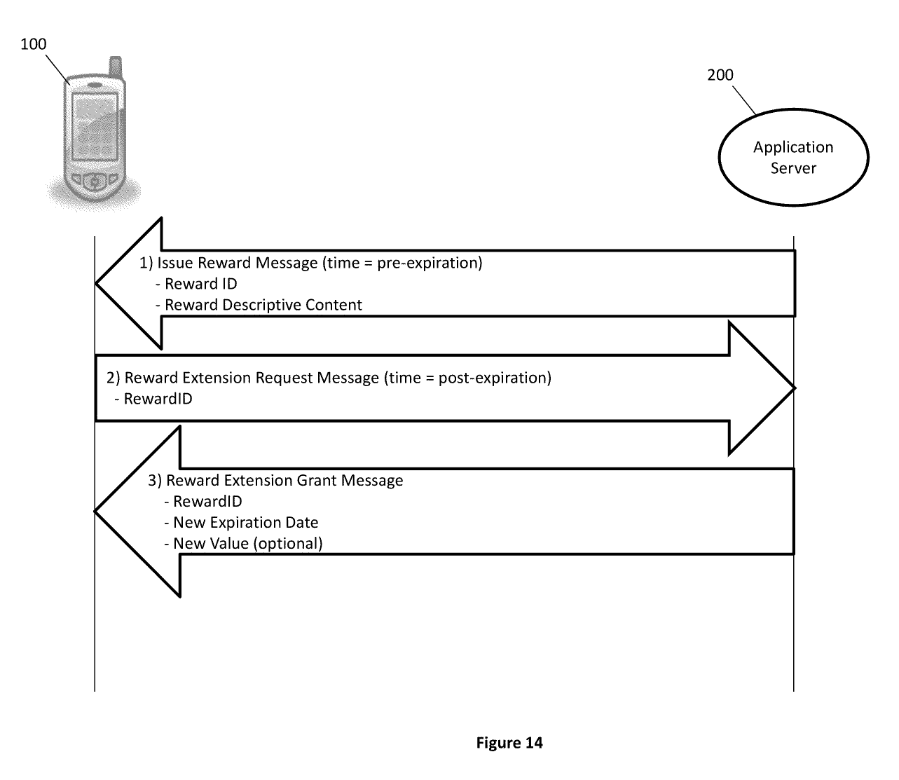

As generally illustrated in FIG. 14, a digital Reward may be granted or issued to a user of the scan-based application system, as previously described in this disclosure (step 1). In one embodiment, the Reward has an associated base value and has an expiration date, after which time the Reward cannot be redeemed by the user. In one embodiment, reward control logic module 114 associated with scan-triggered service client module 104 is adapted to accept input from a user requesting an extension of the expiration date for a Reward that they have previously been granted (step 2). In an alternate embodiment, such a request may also be interpreted as a user request for the issuance of a new copy of the same Reward, where the new Reward has an expiration date that is extended with respect to the expiration date of the original Reward. In one case, the expiration date of the new Reward copy may have no expiration date. In another case, new Rewards with no expiration date may be dynamically removed from a user's Reward wallet at any time, with or without advanced notification of the removal.

In one embodiment, a user may view and select a previously granted Reward in their Reward wallet which has or is about to expire. The user may tap an on-screen button which causes reward control logic module 114 to generate a Reward extension request (step 2), which is communicated to server application module 202 and processed by Reward Control Logic Module 210. Information that can be used to identify the user making the Reward extension request is also communicated to server application module 202. For example, information which can be used to identify the user's account with the survey system may be obtained from a cookie on the user's smartphone. The user identifying information may be provided by client survey module 104 to server application module 202 via a mobile Internet connection. In the case where a cookie is not found on the user's smartphone or the cookie does not contain the necessary user identifying information, the user may be prompted to enter the appropriate login/survey system account credential information (e.g., username and password) and it is at this point that the user's account credential information is effectively provided to server application module 202. Reward Control Logic Module 210 is adapted to receive the Reward extension request and user identifying information and determine whether the Reward extension request should be granted or denied. The determination to grant or deny a Reward extension request may be based, at least in part, on the total number of all Rewards of the same type or Reward campaign that have already been redeemed, whether a previously specified maximum number of allowed extensions threshold has been exceeded, whether it has been previously stated that extensions are allowed for the Reward, whether a maximum extension time period threshold has been crossed (e.g., no extension requests will be granted for this Reward after 2 weeks past the original expiration date), or any other decision logic that involves a parameter associated with the Reward. If a determination is made to grant an expiration date extension, Reward Control Logic Module 210 is adapted to update internal data structures associated with the user's Reward wallet and effectively extend the expiration date of the Reward by a pre-determined amount of time (e.g., extend expiration by 1 week, extend expiration indefinitely, etc.). Alternatively, Reward Control Logic Module 210 is adapted to update internal data structures associated with the user's Reward wallet and issue a new copy of the Reward with an extended or no expiration date (step 3).

In one embodiment, Reward Control Logic Module 210 may, in addition to extending or removing the expiration date, alter the value of the Reward that is to be extended. For example, a request to extend a Reward that is worth $1 may be granted and extended for a period of 1 week, but the value may be reduced to $0.50. In this case, Reward Control Logic Module 210 is adapted to update internal data structures associated with the user's Reward wallet and effectively extend the expiration date of the Reward by a pre-determined amount of time and also update internal data structures associated with the user's Reward wallet so as to alter the value of the extended Reward for the requesting user.

Accordingly, embodiments of the present invention include a system for managing Rewards in a system for distributing and redeeming electronic Rewards, the system comprising:
a computing platform including a processor:
a server application module executable by the processor and configured to:
receive scan code information associated with the scanning of a scan-able code by a user;
in response to receiving the scan code information, distribute a Reward with a first expiration date to the user;
receive, from the user, a request to extend the first expiration date; and
in response to receiving the request, extend the expiration date of the user's Reward to a second expiration date, where the second expiration date is greater than the first expiration date.

Social Media Relay Function

In one embodiment, a scan code driven surveying system of the present is adapted to generate a scan-able survey code (e.g., QR codes, NFC scan-able codes, RFID scan-able codes, etc.) which can be deployed and scanned by users (e.g., smartphone users), where the information obtained from a user scan of this scan code is used to generate messages that may be broadcast, relayed, or generally communicated via a social media communication medium (e.g., Tweet, etc.). For example, a survey system user may scan a survey system QR scan code 510 using scan-triggered service client module 104. Information that can be used to identify the scanned survey response option is communicated to server application module 202. Information that can be used to identify the scanning user is also communicated to server application module 202. For example, information which can be used to identify the user's account with the survey system may be obtained from a cookie that was previously stored on the user's smartphone. The user identifying information may be provided by client survey module 104 to server application module 202 via a mobile Internet connection. In the case where a cookie is not found on the user's smartphone or the cookie does not contain the necessary user identifying information, the user may be prompted to enter the appropriate login/survey system account credential information (e.g., username and password) and it is at this point that the user's account credential information is effectively provided to server application module 202.

Server control logic module 208 is adapted to receive the survey response information and generate a message that contains some or all of the survey response information, or meta-data information associated with or derived from the survey response information (e.g.; statistics, response character (e.g., positive, negative, neutral, etc.), etc.), which in one embodiment, is then broadcast or communicated via a social media communications medium, such as via a Twitter message. In the case of a Twitter message, the message may be a direct message or may be a message that is broadcast to all Followers of a Tweeter, for example, the business or client entity associated with the survey response information (e.g., Fred's Coffee Shop). Alternatively, the Twitter message may be a direct message that is sent to a Twitter Handle associated with Fred's Coffee Shop, and Fred's Coffee Shop may re-Tweet the message. In another alternate embodiment, the message may be broadcast to Followers of the user that scanned the survey scan code. To facilitate social media relay functionality, in one embodiment, server control logic module 208 is adapted to access a social media account associated with the user on behalf of the user and to post information associate with the scanning of a survey response or other service scan-code to the social media account associated with the user. It will be appreciated that in one embodiment, a user's scan-based application system user login credentials may be used to affect login/access to a social media account associated with the user. Alternatively, the scan-based application system (i.e., the system that receives the user's scan information) may store login social media account credential information (e.g., username and password) or otherwise have access to a social media account associated with the user. In one exemplary embodiment, server 200 may include or have access to a social media account user credential data structure 602, which may be accessed by using a user's scan-based application system user login credentials to locate/access the login credentials associated with the user's social media account. As such, the social media “relay” functionality contemplated herein could be performed by the scan-based application system in a manner that is seamless and transparent to the user (i.e., does not require the user to manually log in to their social media account and post the scan information). In effect, the scan-based application system would serve as a proxy, acting on behalf of the user with respect to accessing the user's social media account. In one embodiment, scan code information obtained from a user scan is received by server 200 and server 200 then communicates the scan code information or information associated with the scan code to social media server 600 associated with the user's social media account. As such, information obtained, for example, from the user's scanning of a survey response scan code (e.g., “Service Was Great” @ Joe's Coffee) is transparently communicated to and/or posted on a social media account associated with the scanning user. The user does not need to manually log into their social media account and post the associated scan code survey information to social media server 600, as it is automatically done on behalf of the user by server 200. This service is advantageous, from a user perspective, over solutions that utilize a scan code, which when scanned by a user, simply takes the user to a login WEB page associated with their social media account and prompts them to log in and post content.

To facilitate such social media “relaying”, data storage module 212 may include one or more data structures that contain social media account login credentials or other federated login/identification information sufficient to access a user's social media account (e.g., Twitter, Facebook, etc.), email address information, Twitter handle information, and other social media address identifiers associated with either survey system users (i.e., those who provide survey response information by scanning a scan code) or business clients (i.e., those entities you provision and deploy survey response scan codes). This contact data may be accessed by various modules of server application module 202 to facilitate the social media relay functionality described above.

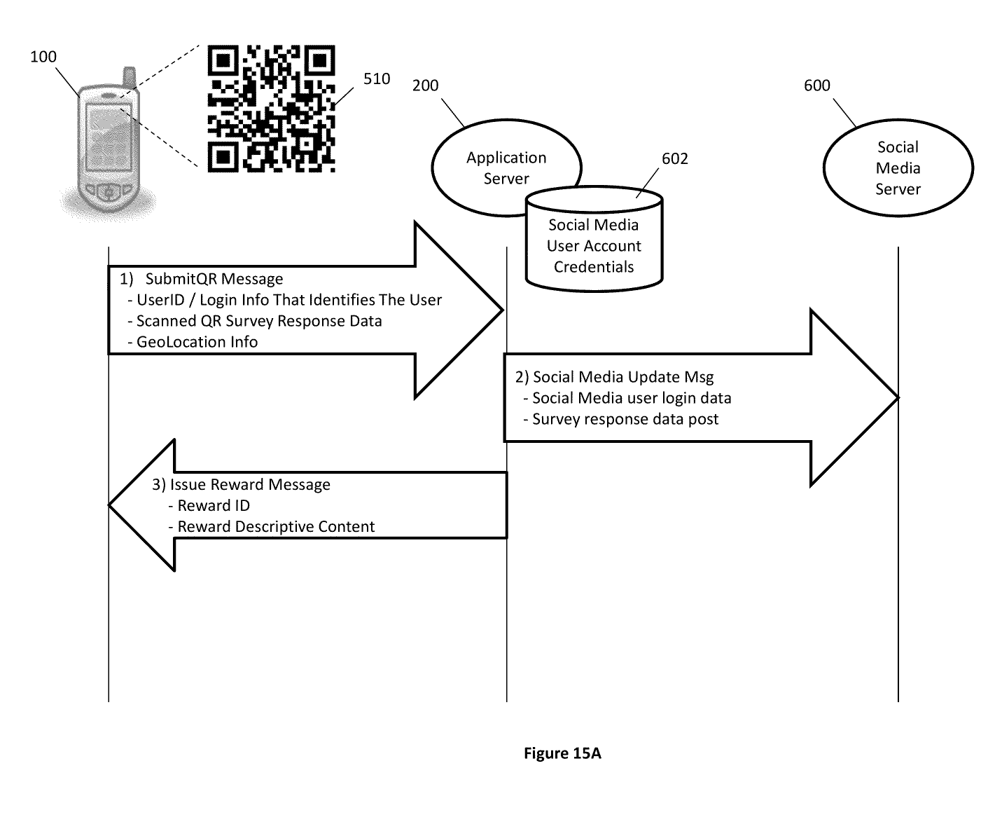

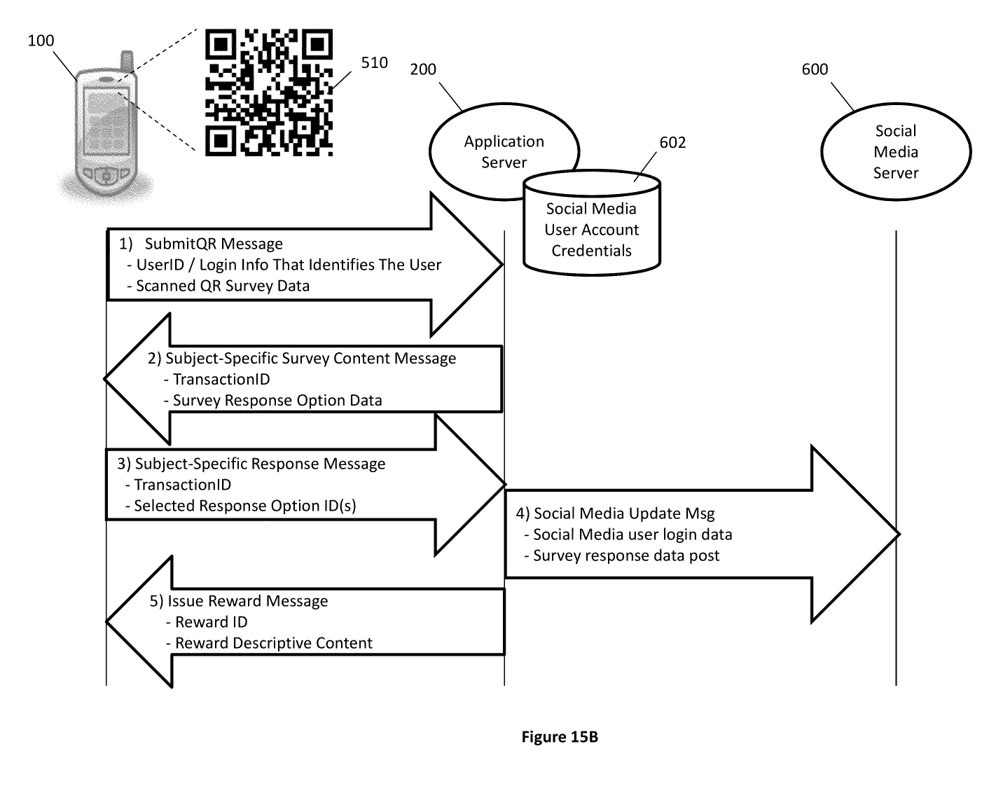

Embodiments of the scan-based social media relay system described above may include Reward distribution and redemption functionality similar to that previously described in this disclosure. As such, a participation Reward may be distributed to a user that scans one or more service codes (e.g., a scan-based survey response code, scan-based event invitation code, scan-based contact list sign up code, etc.), as indicated in steps 3 and 5 of FIGS. 15A and B, respectively. Exemplary social media relay participation Reward distribution and redemption processing may be facilitated by implementations of a Reward Control Logic Module similar to those previously described.

Accordingly, embodiments of the present invention include a system for relaying survey response scan related information via a social media communication medium, the system comprising:
a computing platform including a processor:
a server application module executable by the processor and configured to:
receive survey response information from the scanning of a survey response scan code by a user;
in response to receiving the survey response information, generate a message that contains or is derived from the survey response information; and
use stored social media user account information to access the user's social media account and post the message to the user's social media account.
In various embodiments, posting the message to the user's social media account includes transmitting a social media broadcast message, such as a Tweet.
In various embodiments, posting the message to a social media account includes accessing the user's Facebook account and posting at least a portion of the message contents on the user's Facebook page.
In various embodiments, server application module is also configured to distribute a Reward to the user in response to receipt of the survey response information.

Meta Data Based Sensitivity Analysis

In one embodiment of the present invention, a survey question provisioned by a client entity (i.e., a business owner) may be tagged or have associated therewith a configurable meta-data indicator, which may be used to classify the question in some respect. For example, a Leading Character meta-data indicator may be associated with a survey question, where the Leading Character meta-data indicator may be provisioned as being either positive, negative, or neutral, as generally indicated in data element 326 of Table 5 in FIG. 4. To further illustrate, the survey question “Was your service good?” may be tagged with a Leading Character meta-data indicator value of “positive,” since the question is leading the survey taker in a positive manner. Conversely, the survey question “Was your service bad?” would be tagged with a Leading Character meta-data indicator value of “negative,” since the question is leading the survey taker in a negative manner.

In general, such meta-data tags may be configured via provisioning, administration and billing module 204 at any point before, during or after survey scan codes have been generated and deployed. This meta-data may be stored, for example, in a data structure associated with data storage module 212.

Once meta-data tagged, associated survey response data collected from user scans of the associated survey question/survey response scan codes may be quickly analyzed and reported using the meta-data tags.

In one embodiment, a survey system of the present invention may include logic that is adapted to analyze both the questions and associated meta-data indicator tag values as well as the associated survey response data collected from user scans of those questions/survey response scan codes, and detect and report correlations in user response scan behavior with the meta-data indicator tag values. For example, the survey system may analyze prior survey campaign data and determine that when questions are constructed and presented in a Leading Character—Negative manner, that user scan/response rates generally trend higher. Such knowledge and understanding of underlying user interaction/response characteristics may be very valuable to the business entity that is constructing and deploying surveys intended for these users.

To facilitate such meta-data indicator tagging, data storage module 212 may include one or more data structures that contain meta-data indicator tag information for provisioned survey questions. This meta-data indicator tag data may be accessed by various modules of server application module 202 to facilitate the meta-data indicator tagging functionality described above.

Accordingly, embodiments of the present invention include a system for analyzing survey responses of scan code-based survey system users by tagging survey questions with meta-data indicator tag values, the system comprising:
a computing platform including a processor:
a server application module executable by the processor and configured to:
provision a survey question and associated response options, where a meta-data tag indicator value is associated with the survey question;
associate a scan-able code with the survey question and associated response options;
receive, from a scan-triggered service client module, survey response information associated with a scan of the scan-able code by a user; and
using the meta-data tag indicator value to determine a correlation between the survey responses of the user and the meta-data tag indicator value.

Remote Control of Immediate Notification Service

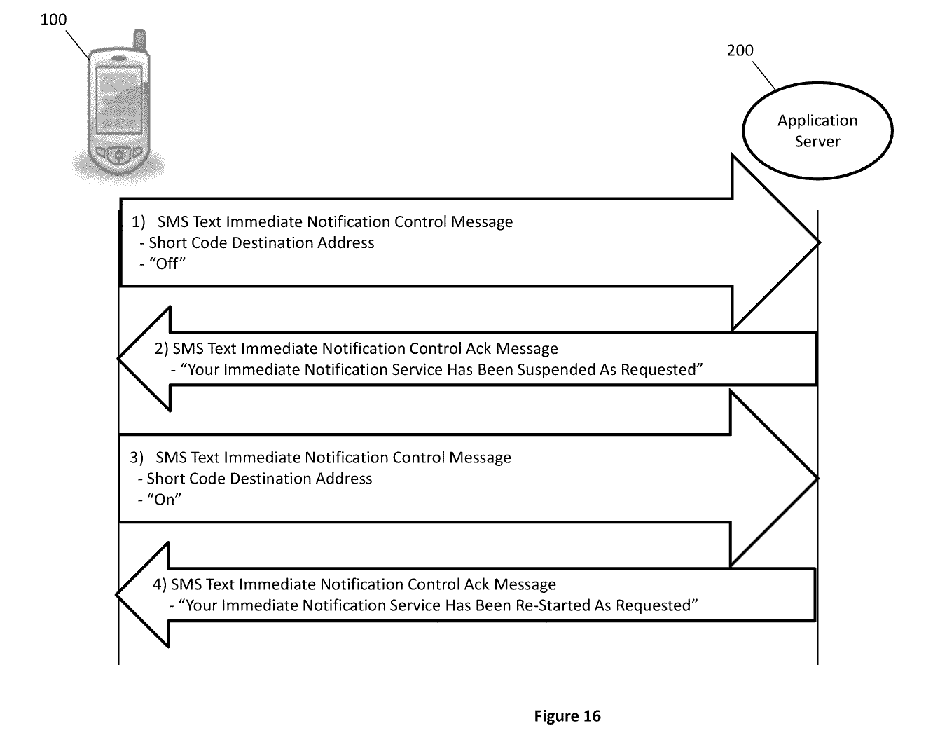

As discussed previously in this disclosure, embodiments of the present invention may include functionality which enables a text message-capable mobile telephone number or instant message contact address, or similar immediate-mode communication contact address to be associated with a survey response scan code. When the survey response scan code is scanned by a user, a text message (or instant message, etc.) is generated by the server application module 202. In one embodiment, Scan Control Logic Module 208 is adapted to generate and transmit a text message to a pre-provisioned mobile telephone number upon receipt of survey response code scan information following a user scan via scan-triggered service client module 104. For example, a when a customer in a restaurant scans a survey response scanned code (e.g., a survey response scan code associated with the survey response “I Had A Bad Experience”), information associated with the scanned survey response is communicated to Scan Control Logic Module 208. In response to receiving the scanned code information, module 208 is adapted to generate a text message and transmit the text message to a mobile telephone number associated with the manager of the restaurant. For example, the text message would serve to notify the restaurant manager that a customer just scanned/reported a bad customer service experience. According to another aspect of the present invention, such immediate notification service may be remotely controlled by the provisioned text or instant message recipient. In one embodiment, as generally illustrated in FIG. 16, server application module 202 is adapted to receive a text message from a mobile telephone number that has previously been provisioned to receive immediate notifications associated with the scanning of a particular survey response via text message service (step 1). Immediate notification control logic associated with Scan Control Logic Module 208 is adapted to receive and process the received text message and consequently perform an immediate notification service control action, such as suspending the generation and sending of further immediate notification messages to the sender or re-starting the generation and sending of further immediate notification messages to the sender. An immediate notification service status update message/information may be returned to the sender, which confirms that immediate notification service has been suspended (step 2). The “calling party” or sender's telephone number identifier associated with the received text message is examined and used to determine if it has been previously provisioned to receive immediate notification service text messages. The text message may include a “called party” telephone number, short code or other destination address that has been implicitly associated with turning off immediate notification service. In such a case, receipt of the text message will cause the “calling party” or sender's mobile telephone number to cease receiving immediate notification text messages until such time as the immediate notification service is re-activated. Alternatively, the text message may include in the body of the text message an explicit pre-determined text string, for example “Off”, which is interpreted by Scan Control Logic Module 208 as an instruction to temporarily de-activate immediate notification service for the calling party mobile telephone number. In a similar manner, to re-activate immediate notification service a text message may be sent to a “called party” telephone number or short code address that is implicitly associated with turning On immediate notification service. Alternatively, the text message may include in the body of the text message a pre-determined text string, for example “On”, which is interpreted by Scan Control Logic Module 208 as an instruction to re-activate immediate notification service for the calling party mobile telephone number (step 3). An immediate notification service status update message/information may be returned to the sender, which confirms that immediate notification service has been re-activated (step 4).

Accordingly, embodiments of the present invention include a system for controlling immediate notification service associated with a scan code-based survey application, the system comprising:
a computing platform including a processor:
a server application module executable by the processor and configured to:
receive a message from an address associated with a sender, where the message is addressed to a destination address associated with a scan code-based survey application;
based on information associated with the message that includes the address associated with the sender, perform an immediate notification service control action for the sender.
In various embodiments, an immediate notification service control action includes suspending the generation and sending of further immediate notification messages to the sender.
In various embodiments, an immediate notification service control action includes initiating the generation and sending of further immediate notification messages to the sender.

User Controlled Scan Anonymity

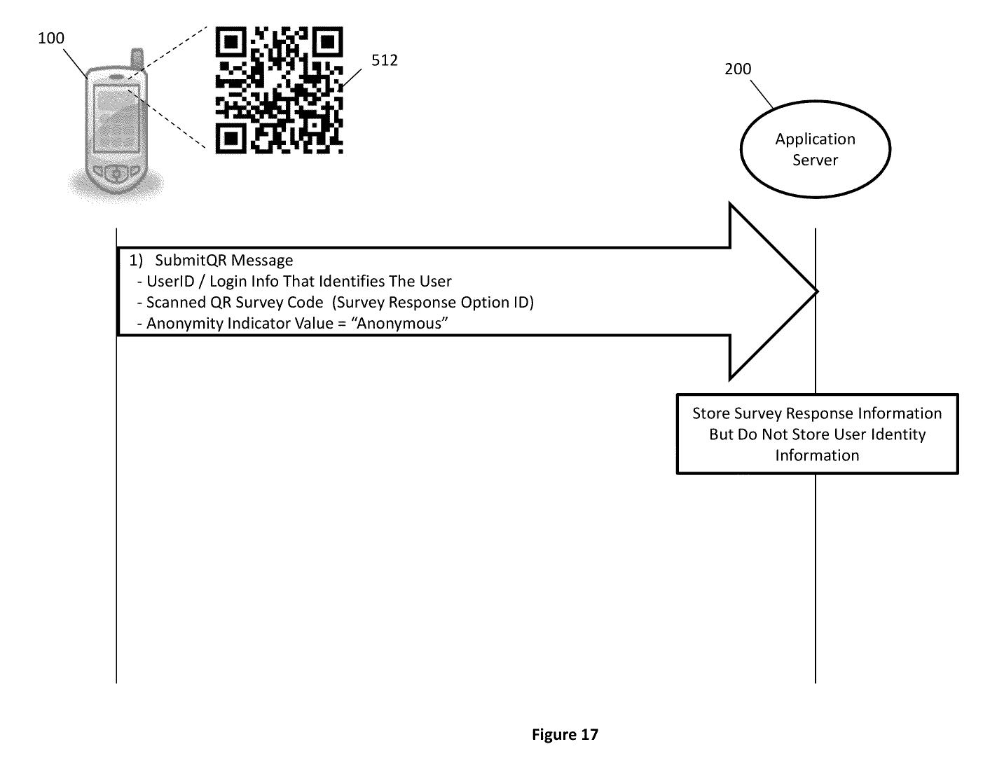

In one embodiment, scan-triggered service client module 104 is adapted to accept input from a user at the time of a survey response scan that causes an indication to be communicated to server application module 202 which instructs Scan Control Logic Module 208 to treat the associated survey response scan as having been submitted anonymously. As generally illustrated in FIG. 17, in one embodiment, an anonymity indicator value is communicated from scan-triggered service client module 104 of a user's mobile communication device 100 to scan-based application server 200 as a result of the scanning of a service scan code 512 (e.g., survey scan code, invitation service scan code, contact list sign up scan code, etc.) by the user (step 1). In this example, the scanning user specifies that the associated scan data should be treated by scan-based application server 200 as being provided by an anonymous user. Consequently, the anonymity indicator value in the message is set to a value, which indicates that anonymity, with respect to this scan, has been requested. As such, Scan Control Logic Module 208 processes and stores the received survey response scan information in data storage module 212 without storing information that identifies or can be used to identify the user that scanned the survey response code.

Accordingly, embodiments of the present invention include a system for allowing a user of a scan code-based survey system to send anonymous survey response information, the system comprising:
a computing platform including a processor:
a server application module executable by the processor and configured to:
receive from a scan-triggered service client module information which may be used to identify a user;
receive from a scan-triggered service client module survey response information associated with the scan of a scan-able survey response code by the user, where the survey response information includes anonymity indicator information; and
in response to receiving the survey response information including the anonymity indicator information, discard the information which may be used to identify the user.

Static and Dynamic Rewards

As discussed previously in this disclosure, embodiments of the present invention may include functionality which enables a user of the scan code-based survey system to receive and redeem Rewards. Such Rewards may be distributed in response to survey participation, at random, or for any other desired distribution reason. According to one aspect of the present invention, two types of Rewards may be distributed to and redeemed by users in a manner similar to that already described herein. The two types of Rewards include what are referred to herein as static-expiration type (s-type) Rewards and a dynamic-expiration type (d-type) Rewards. An s-type Reward is similar to the Rewards that have been described and discussed earlier in this disclosure. S-type Rewards have an associated value, an expiration date, and other information associated with them. A d-type Reward differs primarily from an s-type Reward in that a d-type Reward has no firm expiration date. A d-type Reward has a value and other information associated with it, but the expiration date is either non-existent or, if it is specified, it is understood by users that it may not be honored. A d-type Reward may be removed from a user's Reward wallet at any time after it is granted. Notice of the impending removal of a d-type Reward may or may not be given to the user who possesses it.

Combined deployments of d-type Rewards and s-type Rewards are used by embodiments of the present invention to more precisely and accurately control the Reward redemption cash liability for a business entity that issues the Rewards as part of a Reward Campaign. A survey system business client entity may provision/built a Reward Campaign, which entails the definition of a Reward value, Reward descriptive text, Reward expiration date, and other Reward attributes. Also specified is the total cash liability that is to be associated with the Reward Campaign. This total cash liability value represents the maximum value of all redemptions of this Reward by users that the business client entity is willing to assume. For example, Joe's Coffee Shop may build a Reward for “$1 off” that expires on Sep. 1, 2013. Joe's Coffee Shop may specify a total cash liability value of $100 for this Reward Campaign. This means that if 100 of these Rewards were distributed to 100 users, and all 100 users redeemed them, then the total cash liability of this Reward Campaign would be 100 Rewards×$1 each=$100. If reward control logic module 210 includes logic which permits the distribution of 101 of these Rewards, under the assumption that not all users who receive the Reward will actually redeem it, then the total outstanding cash liability for this Reward Campaign could be $101. If all 101 users that receive the Reward actually redeem it, then the total redeemed cash amount ($101) would exceed the stated total cash liability limit for this Reward Campaign of $100. The properly coordinated use of s-type and d-type Rewards provides a solution to this problem.

In one embodiment, reward control logic module 210 includes logic which coordinates the distribution of s-type and d-type Rewards associated with a Reward Campaign. In one simple example of the type of coordinated distribution logic that may be used, reward control logic module 210 is adapted to incrementally distribute s-type Rewards up to the point where the product of the value of the s-type Reward and the number of s-type Rewards distributed is equal to half the maximum cash liability limit that has been provisioned for the Reward Campaign. For the purpose of illustration, assume the s-type Reward has an associated cash value of $1 and that the total or maximum cash liability limit provisioned for this Reward Campaign is $100. Consequently, 50 s-type Rewards have been distributed, which represents $50 in cash liability to the business client entity with whom they will be redeemed. At this point, if all of the s-type Rewards are redeemed, only half of the maximum cash liability limit will have been “spent” by the business client entity. Reward control logic module 210 now begins incrementally distributing only d-type Rewards to users. While these d-type Rewards have the same cash value as the previously distributed s-type Rewards, the d-type Rewards differ in that they can be revoked and retrieved from a user's Reward wallet at any time. Thus, continuing with this example, reward control logic module 210 may distribute 300 additional d-type Rewards, which represents another $300 in potential cash liability to the business client entity. Reward control logic module 210 is adapted to monitor the redemptions of all Rewards, both s-type and d-type, and calculate the current total redeemed cash value associated with all these Reward Campaign redemptions. As the current total redeemed cash value for the Reward Campaign approaches the provisioned total or maximum cash liability limit, reward control logic module 210 is adapted to begin revoking and retrieving some or all of the d-type Rewards before they can be redeemed by users. In this manner, reward control logic module 210 is adapted to use coordinated s-type and d-type Reward deployments in tandem with active, real-time Reward redemption monitoring to efficiently manage redemption cash liability associated with a Reward Campaign such that the provisioned total or maximum cash liability limit is not exceeded.

Accordingly, embodiments of the present invention include a system for distributing and redeeming Rewards to users of a scan code-based survey system, the system comprising:
a computing platform including a processor:
a server application module executable by the processor and configured to:
create a Reward campaign which has a maximum cash liability threshold value;
distribute static Rewards associated with a Reward campaign to a first set of users, where each static Reward has a cash value;
distribute dynamic Rewards associated with the Reward campaign to a second set of users, where each dynamic Reward has a cash value;
Redeem at least a portion of the static and dynamic Rewards; and
In response to determining that the total cash value of static and dynamic Reward redemptions exceeds the threshold value, revoke at least a portion of the unredeemed dynamic Rewards.

Survey Response Scan Preview

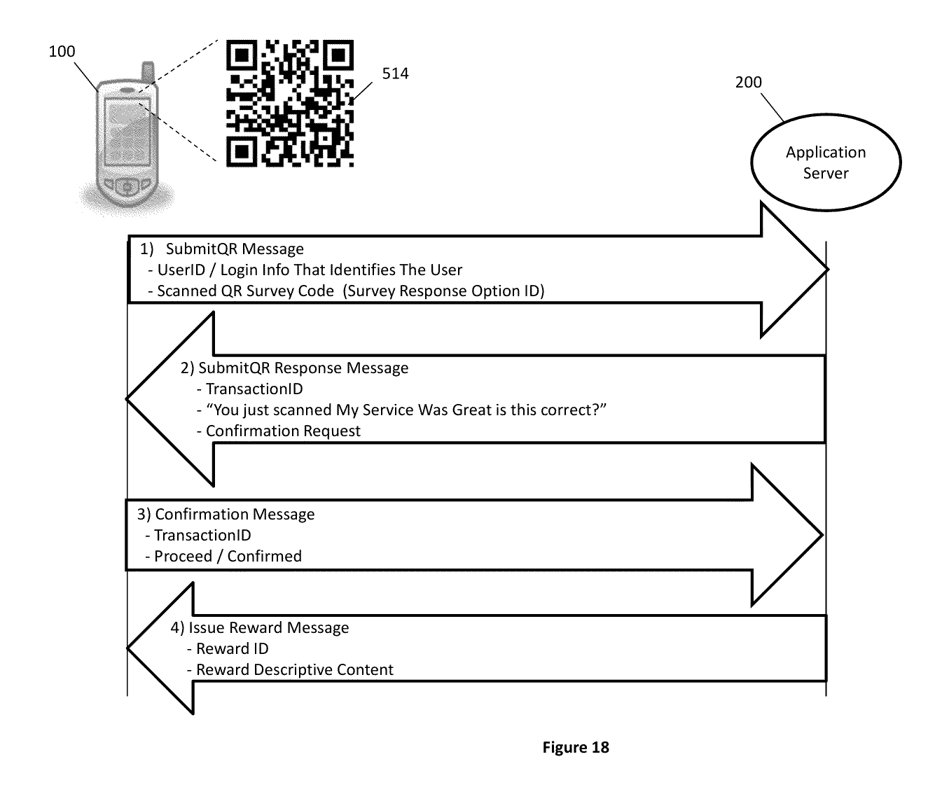

In one embodiment, scan-triggered service client module 104 is adapted to provide a preview of a scanned survey response code 514 before the associated survey response code information is communicated to server application module 202, as generally indicated in FIG. 18. Scan-triggered service client module 104 provides the user who is scanning the survey response code with the option to proceed and submit the survey response scan information or to abort the scan. In one embodiment, scan-able code reader module 106 is adapted to scan and decode the scan-able survey response code, Scan Control Logic Module 112 communicates a preview request message to server application module 202 (step 1). Server application module 202 receives the preview request message and passes the request message to Scan Control Logic Module 208 for processing. Scan Control Logic Module 208 uses information contained in the request message to obtain the associated response option text from data storage module 212. The response option text information is placed in a reply message, which is communicated from server application module 202 back to scan-triggered service client module 104, where it is displayed to the user by user interface module 108 (step 2). Also displayed to the user is tap-able button or other user-controlled selection means by which the user can select whether they would like to submit the displayed survey response. In one embodiment, if the user chooses to submit the survey response, scan-triggered service client module 104 communicates a preview confirmation message to server application module 202 (step 3). Scan Control Logic Module 208 uses information contained in the confirmation message in conjunction with the survey response information previously received via the preview request message to log or commit the survey response and associated user identifying information to data storage module 212. In another embodiment, if the user chooses to submit the survey response, scan-triggered service client module 104 communicates the scanned survey response information to server application module 202. Scan Control Logic Module 208 uses the information to log or commit the survey response and associated user identifying information to data storage module 212.

Embodiments of the scan-based application system described above that provides such scan preview service may include Reward distribution and redemption functionality similar to that previously described in this disclosure. As such, a participation Reward may be distributed to a user that scans one or more service codes (e.g., a scan-based survey response code, scan-based event invitation code, scan-based contact list sign up code, etc.), as indicated in step 4. Exemplary participation Reward distribution and redemption processing may be facilitated by implementations of a Reward Control Logic Module similar to those previously described.

Accordingly, embodiments of the present invention include a system for previewing a survey response scan code associated with a scan code-based survey system, the system, comprising:
a computing platform including a processor:
a server application module executable by the processor and configured to:
receive from a scan-triggered service client module information which may be used to identify a survey response associated with a scan-able survey response scan code;
retrieve text description information associated with the identified survey response;
send the text description information to the scan-triggered service client module where it is displayed to a user; and
receive from a scan-triggered service client module information which may be used to confirm that the previously received survey response information should be committed to storage.

Use of Encrypted Uniform Resource Locator (URL)-Based Scan Codes

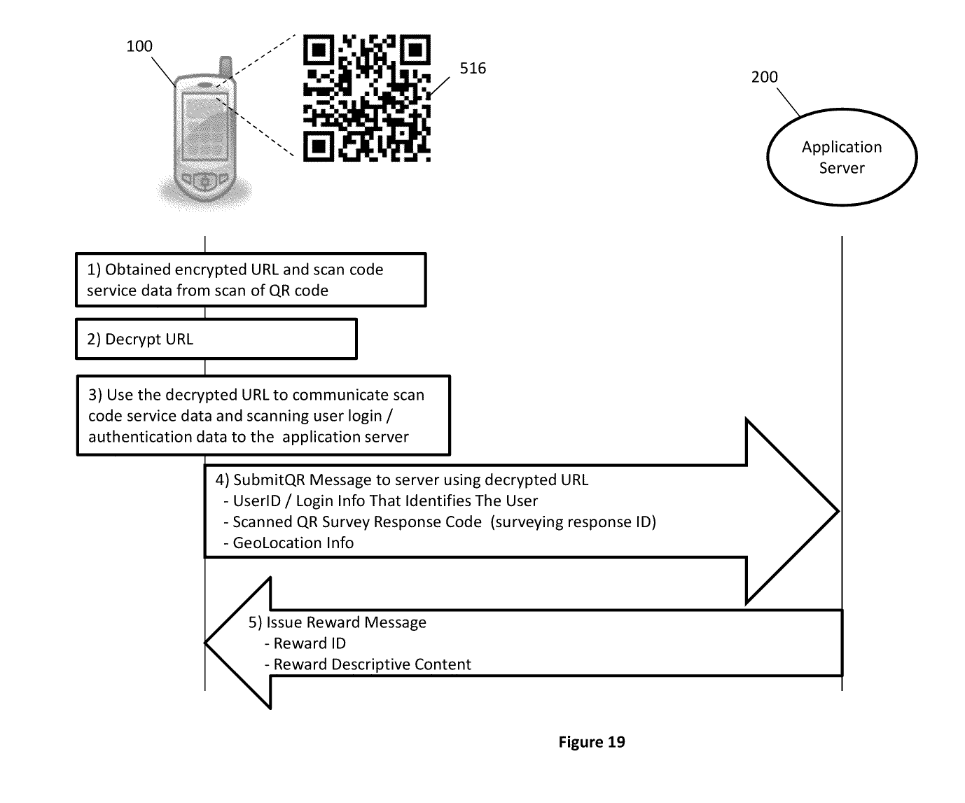

In one embodiment of the present invention, scan-able survey response codes (e.g., QR encoded, NFC encoded, RFID encoded, etc.) are generated by the scan code-based survey system, which include encrypted or obfuscated uniform resource locator (URL) information, where the URL information in decrypted/de-obfuscated form can be used to identify a WEB-based resource associated with the scan code-based survey system, as generally illustrated in FIG. 19. These scan-codes may be deployed and subsequently scanned by users in a manner that is similar to that previously described in this disclosure.

Scan-able code reader module 106, which is associated with scan-triggered service client module 104, is adapted to scan a service scan code 516 (e.g., survey response code, invitation service code, contact list subscription code, etc.) that includes the encrypted or obfuscated URL information (step 1). Scan-able code reader module 106 is further adapted to access encryption key information from data storage module 116 that may be used to decrypt the encrypted URL information (step 2). In the case of an obfuscated URL, scan-able code reader module 106 is adapted to access information from data storage module 116 that may be used to perform de-obfuscation processing on the obfuscated URL information. In alternate embodiments of the present invention, scan-able code reader module 106 may obtain the necessary encryption key or de-obfuscation instructions from an external source, such as a network-based application server. In either case, the result is that the encrypted or obfuscated URL information that is obtained directly from the QR, NFC, or RFID scan is decoded into a useable URL that is associated with WEB-based servers which host or facilitate access to server application module 202. In this example, the exemplary service scan code 500 is associated with a survey response. Once the useable URL is obtained, scan-triggered service client module 104 communicates the scanned survey response information to server application module 202 using the URL, where the survey response information is processed in a manner similar to that previously described in this disclosure (step 4).

Using this same approach, not only the URL obtained from a scanned survey response code or contact list subscription code, but any other identifier information encoded in the scan-able code (e.g., client entity identifier, survey response option identifier, location identifier, and other identifiers) may also be encrypted or obfuscated. As such, scan-able code reader module 106 is further adapted to access encryption key information from data storage module 116 that may be used to decrypt the encrypted identifier information. In the case of obfuscated identifier information, scan-able code reader module 106 is adapted to access information from data storage module 116 that may be used to perform de-obfuscation processing on the obfuscated identifier information. In alternate embodiments of the present invention, scan-able code reader module 106 may obtain the necessary encryption key or de-obfuscation instructions from an external source, such as a network-based application server. In either case, the result is that the encrypted or obfuscated identifier information that is obtained directly from the QR, NFC, or RFID scan is decoded. Once the decoded identifier information is obtained, scan-triggered service client module 104 communicates the scanned contact list subscription or survey response information, including the decoded identifier information, to server application module 202 using the URL, where the information it is processed in a manner similar to that previously described in this disclosure.

In another embodiment of the present invention, scan-able code reader module 106, which is associated with scan-triggered service client module 104, is adapted to scan a survey response code or contact list subscription code that includes the URL information that can be used to identify a WEB-based resource associated with the scan code-based survey system. In this embodiment, scan-triggered service client module 104 is adapted to ignore some or all of the URL information obtained from the scan, and instead use alternate URL information to contact a WEB-based resource associated with the scan code-based survey system. This alternate URL information may, for example, be provisioned in scan-triggered service client module 104 prior to the scan and may be stored in data storage module 116.

Embodiments of the scan-based application system described above that provides such scan preview service may include Reward distribution and redemption functionality similar to that previously described in this disclosure. As such, a participation Reward may be distributed to a user that scans one or more service codes (e.g., a scan-based survey response code, scan-based event invitation code, scan-based contact list sign up code, etc.), as indicated in step 5. Exemplary participation Reward distribution and redemption processing may be facilitated by implementations of a Reward Control Logic Module similar to those previously described.

Accordingly, embodiments of the present invention include a system for using an encrypted or obfuscated resource identifier to access network-based resources associated with a scan code-based survey system, the system comprising:

a computing platform including a processor:
a scan triggered service client module executable by the processor and configured to:
scan a survey response scan-able code to obtain a resource identifier information associated with a scan-based survey system, where the resource identifier information is encrypted or obfuscated;
decrypt or de-obfuscate the resource identifier information; and
use the decrypted or de-obfuscated resource identifier information to access network-based resources associated with the scan code-based survey system.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for distributing and administering digital rewards associated with the scanning of a scan-triggered application service scan code, the system comprising:
a computing platform including a processor:
a server application module executable by the processor and configured to:
receive scanned service code information communicated by a scan-triggered service client module;
in response to receiving the service code information, grant a reward with an associated first value to a user at a first time; and
at a second time, alter the worth of the reward to a second value.

2. The system of claim 1 where the scan-triggered service client module resides on a mobile communication device.

3. The system of claim 1 where altering the worth of the reward to a second value includes increasing the value of the reward.

4. The system of claim 1 including at a third time, alter the worth of the reward to a third value which is less than the second value.

5. The system of claim 1 where the service code is a code associated with a survey response option.

6. A method for distributing and administering digital rewards associated with the scanning of scan-triggered application service scan code, the method comprising:
receiving scanned service code information communicated by a scan-triggered service client module;
in response to receiving the service code information, granting a reward with an associated first value to a user at a first time; and
at a second time, altering the worth of the reward to a second value.

7. The method of claim 6 where a scan-triggered service client module includes a scan-triggered service client module residing on a mobile communication device.

8. The method of claim 6 where altering the worth of the reward to a second value includes increasing the value of the reward.

9. The method of claim 6 including at a third time, altering the worth of the reward to a third value which is less than the second value.

10. The method of claim 6 where the service code is a code associated with a survey response option.

11. A non-transitory computer readable medium having stored thereon executable instructions that when executed by the processor of a computer control the computer to perform steps comprising:
receiving scanned service code information communicated by a scan-triggered service client module;
in response to receiving the service code information, granting a reward with an associated first value to a user at a first time; and
at a second time, altering the worth of the reward to a second value.

12. The non-transitory computer readable medium of claim 11 where a scan-triggered service client module includes a scan-triggered service client module residing on a mobile communication device.

13. The non-transitory computer readable medium of claim 11 where altering the worth of the reward to a second value includes increasing the value of the reward.

14. The non-transitory computer readable medium of claim 11 including at a third time, altering the worth of the reward to a third value which is less than the second value.

15. The non-transitory computer readable medium of claim 11 where the service code is a code associated with a survey response option.
